(19) United States
(12) Patent Application Publication
(10) Pub. No.: US 2026/0350473 A1
(43) Pub. Date: Nov. 5, 2026

(54) Systems and Methods for Task Multiplexing in Machine Learning

(71) Applicant: Northeastern University, Boston, MA (US)

(72) Inventors: Francesco Restuccia, Boston, MA (US); Mohammad Abdi, Boston, MA (US); Francesca Meneghello, Boston, MA (US)

(21) Appl. No.: 19/667,370

(22) Filed: May 4, 2026

Related U.S. Application Data
(60) Provisional application No. 63/798,755, filed on May 2, 2025.

(51) Int. Cl. G06N 20/00

(52) U.S. Cl. CPC G06N 20/00

(57) ABSTRACT

A computer-based system and corresponding computer-implemented method of multiplexing are provided. Multiple protected keys corresponding to multiple task inputs for a machine learning (ML) model are generated. The task inputs and generated protected keys are computationally bound. The computationally bound task inputs and the generated protected keys are transformed into a compositional data structure. A transmitter model is implemented based on the ML model. The transmitter model is associated with a receiver model. The transmitter model is configured to perform joint processing of the compositional data structure and produce a multiplexed output. The multiplexed output represents partial multiplexed execution of the ML model on the task inputs.

### RELATED APPLICATION

This application claims the benefit of U.S. Provisional Application No. 63/798,455, filed on May 2, 2025. The entire teachings of the above application are incorporated herein by reference.

### GOVERNMENT SUPPORT

This invention was made with government support under Grant Numbers ECCS-2329013, ECCS-2229472 and CNS-2134973 awarded by the National Science Foundation, under Grant Number FA6550-23-1-0261 awarded by the U.S. Air Force Office of Scientific Research, and under Grant Number N00014-23-1-2221 awarded by the U.S. Office of Naval Research. The Government has certain rights in the invention.

### BACKGROUND

Artificial intelligence (AI) models, e.g., machine learning models, may be used to execute processing tasks. In some mobile applications, processing tasks may be executed based on AI models utilizing edge servers.

### SUMMARY

Some mobile applications demand high-rate, low-latency execution of processing tasks based on artificial intelligence (AI) models, e.g., machine learning (ML) models, utilizing edge servers. Problematically, however, traditional approaches cannot handle high-rate inputs. Existing approaches also incur excessive communication latency when transferring data from a mobile device to an edge server. These are just some examples of performance bottlenecks in conventional approaches. It thus follows that functionality with increased performance, speed, and efficiency is needed. Embodiments provide such functionality.

An example embodiment introduces communication-aware distributed computing that addresses the shortcomings of existing approaches by intertwining Multiple-Input Multiple-Output (MIMO) computation with MIMO communication.

An example embodiment is directed to a computer-based system for multiplexing. The system includes at least one processor and a memory with computer code instructions stored or held thereon. The at least one processor and the memory, with the computer code instructions, are configured to cause the system to generate multiple protected keys corresponding to multiple input tasks for an ML model. The at least one processor and the memory, with the computer code instructions, are further configured to cause the system to computationally bind the input tasks and generated protected keys. The at least one processor and the memory, with the computer code instructions, are further configured to cause the system to transform computationally bound input tasks and the generated protected keys into a compositional data structure. The at least one processor and the memory, with the computer code instructions, are further configured to cause the system to implement a transmitter model based on the ML model. The transmitter model is associated with a receiver model. The transmitter model is configured to perform joint processing of the compositional data structure and produce a multiplexed output. The multiplexed output represents partial multiplexed execution of the ML model on the input tasks. According to one such embodiment, the ML model may be a neural network model. In another such embodiment, the input tasks may relate to an object detection task, a text analysis task, an image classification task, or a sentiment analysis task. In yet another such embodiment, the system may be implemented at least in part in a mobile device. The mobile device may be a virtual reality (VR) device, an augmented reality (AR) device, smart glasses, a smartphone, a smartwatch, a tablet, a laptop, a robot, a wearable device, a medical device, an unmanned aerial vehicle (UAV), or another mobile device.

In an example embodiment, the at least one processor and the memory, with the computer code instructions, may be further configured to cause the system to implement a modulator configured to generate at least one modulated output based on the multiplexed output. The at least one modulated output may be capable of being transmitted via at least one communications channel to the receiver model to produce multiple task outputs corresponding to the input tasks. The task outputs may represent full multiplexed execution of the ML model on the input tasks.

According to an embodiment, the at least one processor and the memory, with the computer code instructions, may be further configured to cause the system to implement a stochastic precoding model configured to transform the multiplexed output into an encoded output based on channel state information (CSI) associated with the at least one communications channel. In one such embodiment, the stochastic precoding model may be configured to transform the multiplexed output by: (1) transforming the multiplexed output into a complex tensor; (2) computing a precoding tensor based on the complex tensor and the CSI; and (3) generating the encoded output based on a probability distribution associated with the computed precoding tensor. According to another such embodiment, the at least one processor and the memory, with the computer code instructions, may be further configured to cause the system to dynamically determine the CSI by: (1) transmitting pilot data to a remote system associated with the receiver model and (2) receiving the CSI from the remote system. The received CSI may be adapted to at least one condition of the at least one communications channel. In yet another such embodiment, the at least one processor and the memory, with the computer code instructions, may be further configured to cause the system to dynamically determine the CSI by: (1) generating a pilot input based on training data associated with the ML model, the pilot input having a predetermined output; (2) injecting the generated pilot input into the input tasks at an index determined at least in part based on a seed value associated with the transmitter model and the receiver model; and (3) determining the CSI based on a difference between the predetermined output and an output of the task outputs at the index.

In an example embodiment, the at least one modulated output may include a plurality of modulated outputs. The modulator may be configured to generate the plurality of modulated outputs using a multiplexing technique. The multiplexing technique may be spatial multiplexing, time-division multiplexing, frequency-division multiplexing, or code-division multiplexing.

According to an example embodiment, the transmitter model may include a first set of parameters. The receiver model may include a second set of parameters. The receiver model may be associated with a demodulator. The at least one communications channel may be associated with a channel model. The at least one processor and the memory, with the computer code instructions, may be further configured to cause the system to determine the first set of parameters and second set of parameters by: (1) generating a training metric based on a weighting metric and probability distributions associated with: (i) the transmitter model, (ii) the modulator, (iii) the channel model, (iv) the receiver model, and (v) the demodulator and (2) optimizing the generated training metric based on training data associated with the ML model.

In an example embodiment, the at least one communications channel may be at least one wired or wireless communications channel.

According to an example embodiment, in implementing the transmitter model, the at least one processor and the memory, with the computer code instructions, may be configured to cause the system to partition the ML model into a pair of processing functions. The transmitter model may be configured to perform the joint processing based on a first processing function of the pair of processing functions. In one such embodiment, the ML model may include a non-differentiable function. In partitioning the ML model, the at least one processor and the memory, with the computer code instructions, may be configured to cause the system to (1) transform the non-differentiable function into a differentiable function and (2) partition the differentiable function into the pair of processing functions. According to another such embodiment, in transforming the non-differentiable function, the at least one processor and the memory, with the computer code instructions, may be configured to cause the system to re-parameterize the non-differentiable function.

In an example embodiment, the generated protected keys may be configured to provide corresponding protected subspaces for processing the input tasks.

According to an example embodiment, in computationally binding the input tasks and generated protected keys, the at least one processor and the memory, with the computer code instructions, may be configured to cause the system to use a holographic reduced representations (HRR) technique.

In an example embodiment, in transforming computationally bound input tasks and the generated protected keys into the compositional data structure, the at least one processor and the memory, with the computer code instructions, may be configured to cause the system to use an element-wise summation technique.

According to an example embodiment, the at least one processor and the memory, with the computer code instructions, may be further configured to cause the system to implement a disjoint processing model based on at least part of the transmitter model. The disjoint processing model may be configured to transform the input tasks into higher-dimensional representations. In one such embodiment, the higher-dimensional representations may be configured to isolate processing of the computationally bound input tasks.

Alternative computer-implemented method embodiments parallel those described above in connection with the example computer-based system embodiment above.

Another example embodiment is directed to a computer-implemented method of demultiplexing. The method begins by implementing a demodulator configured to generate a multiplexed input based on a modulated input received via at least one communications channel from a transmitter model associated with an ML model. The multiplexed input represents partial multiplexed execution of the ML model on multiple input tasks. A receiver model is implemented based on the ML model. The receiver model is configured to perform joint processing of the multiplexed input and produce a compositional data structure. The compositional data structure is transformed into multiple task outputs computationally bound with protected keys. The task outputs represent full multiplexed execution of the ML model on the input tasks. The task outputs are computationally unbound from the protected keys.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a computer-based system that includes an example embodiment of the present disclosure.

FIG. 2 is a block diagram of an example embodiment of a semantic multiplexing architecture.

FIG. 3 is a block diagram of an example embodiment of an architecture with a transmitter and receiver.

FIG. 4 is a block diagram of an example embodiment of an architecture with a neural network for task execution.

FIG. 5 is a block diagram of an example embodiment of an architecture with a precoder and postcoder.

FIG. 6 is a block diagram of an example embodiment of a probabilistic system model.

FIG. 7 is a block diagram of an example embodiment of an architecture with communication and semantic channel sounding.

FIG. 8 is a composite image of an example embodiment of an experimental setup for real-world evaluation.

FIGS. 9A-9C are plots depicting accuracy results of scalability evaluations for image classification.

FIG. 10 is a plot depicting accuracy results of scalability evaluations for sentiment analysis.

FIGS. 11A-11C are plots depicting latency.

FIGS. 12A-12C are plots depicting energy consumption.

FIGS. 13A-13C are plots depicting communication overhead.

FIG. 14 is a plot depicting adaptation accuracy.

FIG. 15 is a flow diagram of an example embodiment of a computer-implemented method.

FIG. 16 is a block diagram of an example embodiment of an internal structure of a computer optionally within an embodiment disclosed herein.

### DETAILED DESCRIPTION

A description of example embodiments follows.

Mobile devices may require the parallel execution of several processing tasks, such as by utilizing edge servers for computational efficiency. However, existing communication systems only support parallel transmissions at the bit level. This fundamentally limits the number of tasks that can be executed concurrently. To address this bottleneck, embodiments introduce the new concept of semantic multiplexing. An example embodiment shifts stream multiplexing from bits to tasks by merging multiple task inputs into a single semantic representation. As such, an example embodiment can multiplex more tasks than the number of physical streams by adding a degree of freedom (semantic level) to the system rather than adding antennas or increasing bandwidth. An example embodiment was prototyped and evaluated in an experimental testbed with a Jetson Orin Nano™ (NVIDIA Corp., Sunnyvale, CA) and millimeter-wave software-defined radios (SDRs). The example embodiment's performance was measured on multiplexed image classification and sentiment analysis tasks and compared to several existing baseline approaches in semantic communications (SemCom). The experiments demonstrate that embodiments can simultaneously execute multiple computing tasks, beyond the capacity of just the physical streams, while preserving task accuracy. For instance, an example embodiment allows the number of tasks multiplexed over a 4×4 channel to be increased from 2 to 8 with less than a 4% decrease in image classification accuracy. Moreover, an example embodiment reduces latency, energy consumption, and communication load by up to 8×, 25× and 54×, respectively, compared to existing baselines, while maintaining comparable performance.

Embodiments provide semantic multiplexing, including new techniques to jointly process and transmit several computing tasks at the semantic layer. A bottleneck of existing approaches is the separate optimization of the communication and computation pipelines, which notably requires a complicated design. Embodiments address this and other drawbacks of conventional approaches. For instance, an example embodiment may analytically formulate a probabilistic model of a transmitter and receiver system and train the model in a task-oriented fashion. A precoder and postcoder may be designed to allow the transmitter and receiver to compensate for wireless channel impairments. To enable joint optimization of communication and computation objectives, a wireless channel model may be developed and integrated into the system. An example embodiment may provide a semantic channel sounding technique that surpasses existing approaches and allows semantic multiplexing modules to adapt to fluctuating channel conditions.

An example embodiment was prototyped on an experimental testbed and its performance was extensively evaluated its performance on image classification and sentiment analysis tasks. The results demonstrate that example embodiments outperform conventional approaches and—by providing semantic multiplexing—allow a system to multiplex more tasks than can be achieved by existing approaches with a given number of physical streams. As discussed in more detail hereinbelow, the results further show that multiplexing performance changes based on the specific task and the approach being employed, e.g., semantic processing. The experimental investigation also revealed that the design of disjoint processing before binding input tasks may affect performance.

For the first time, embodiments introduce and validate a new concept: the number of tasks that can be semantically multiplexed in a communication system is greater the number of available physical streams.

An example embodiment embeds a Multiple-Input Multiple-Output (MIMO) communication channel in a deep neural network (DNN) design and additionally integrates task-oriented precoding and postcoding modules, which contribute to the task execution. By unifying channel coding and DNN inference in a single architecture, an example embodiment leverages the communication channel as part of the computation pipeline, thereby drastically reducing the energy consumption and end-to-end latency compared to existing approaches. An example embodiment provides a technique for using task-oriented pilot signals to adapt to dynamic communication environments.

Subsequent to the filing of U.S. Provisional Application No. 63/798,455, aspects of the invention have been published in Abdi et al., “Semantic Multiplexing,” arXiv preprint arXiv: 2511.13779, Nov. 16, 2025, pp. 1-16, which is herein incorporated by reference in its entirety.

### INTRODUCTION

Modern mobile devices may need to continuously offload computing tasks (e.g., object detection, semantic segmentation, etc.) to edge servers to process high data rate multimedia inputs without prematurely exhausting the devices' batteries. Such computing tasks may need to be executed with ultra-low latency to avoid user discomfort. For instance, so-called “VR sickness” caused by high latency is a form of visually induced motion sickness where a virtual world fails to update instantly with a user's movements, creating a conflict between what the eyes see and what the inner ear feels. While existing MIMO communication approaches allow the simultaneous transmission (i.e., multiplexing) of multiple streams of bits in the same time and/or frequency domains, this fails to provide adequate support for emerging applications (e.g., VR and AR).

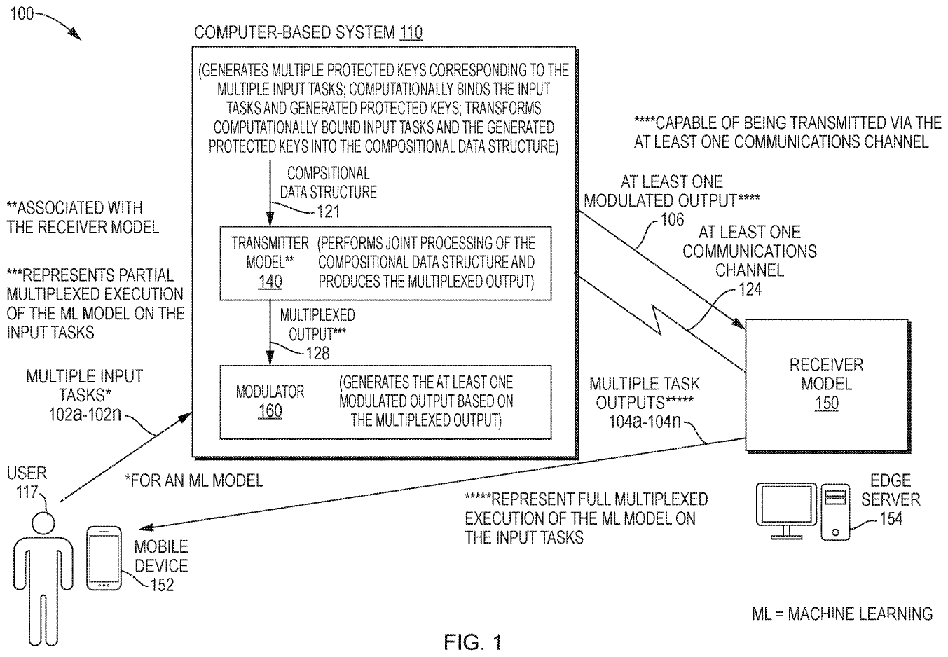

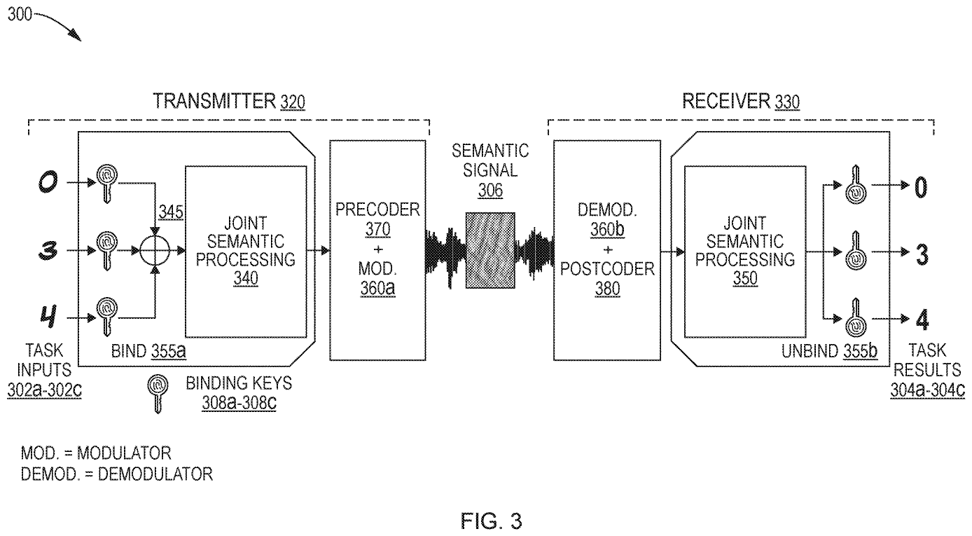

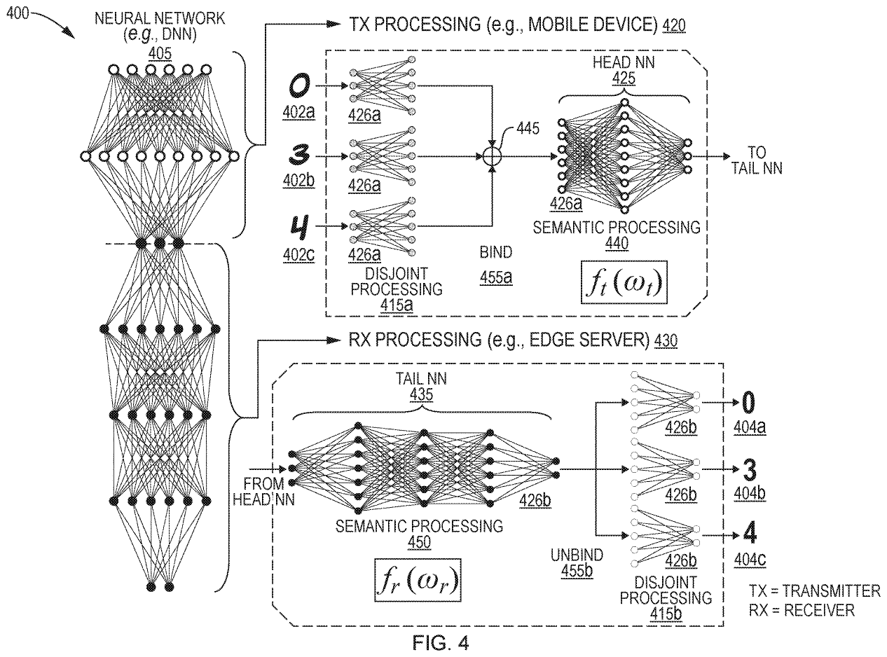

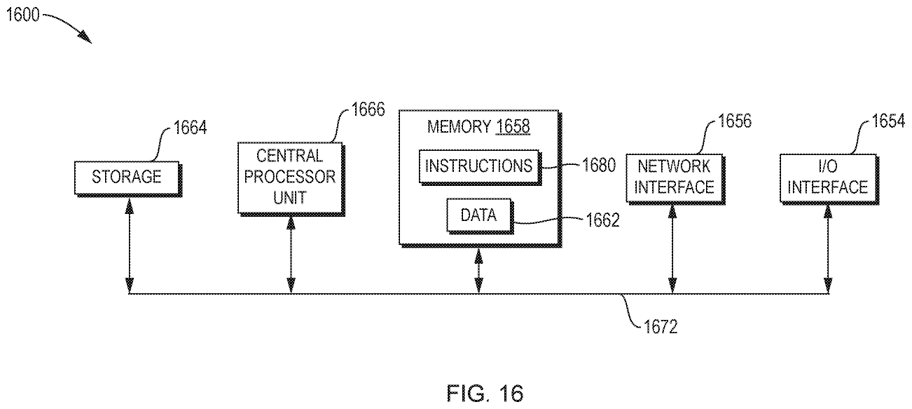

FIG. 1 is a block diagram of a computer-based system 110 that includes an example embodiment of the present disclosure. In the example embodiment of FIG. 1, the system 110 comprises at least one processor (not shown) and memory (not shown) with computer code instructions (not shown) stored thereon, such as disclosed further below with respect to FIG. 16. The at least one processor and the memory, with the computer code instructions, are configured to cause the system 110 to generate multiple protected keys (e.g., 308a-308c (FIG. 3)) corresponding to multiple input tasks 102a-102n for an ML model (e.g., 405 (FIG. 4)). In an embodiment, the input tasks 102a-102n may be received from any suitable known computing device, such as mobile device 152, or from user 117 operating a computing device. The at least one processor and the memory, with the computer code instructions, are further configured to cause the system 110 to computationally bind the input tasks 102a-102n and generated protected keys. The at least one processor and the memory, with the computer code instructions, are further configured to cause the system to transform computationally bound input tasks and the generated protected keys into a compositional data structure 121. The at least one processor and the memory, with the computer code instructions, are further configured to cause the system 110 to implement a transmitter model 140 based on the ML model. The transmitter model 140 is associated with a receiver model 150. In an embodiment, the receiver model 150 may be implemented on any suitable computing device, such as edge server 154. The transmitter model 140 is configured to perform joint processing of the compositional data structure 121 and produce a multiplexed output 128. The multiplexed output 128 represents partial multiplexed execution of the ML model on the input tasks 102a-102n. According to one such embodiment, the ML model may be a neural network model (not shown). In another such embodiment, the input tasks 102a-102n may relate to an object detection task, a text analysis task, an image classification task, or a sentiment analysis task. In yet another such embodiment, the system 110 may be implemented at least in part in the mobile device 152. The mobile device 152 may be a virtual reality (VR) device, an augmented reality (AR) device, smart glasses, a smartphone, a smartwatch, a tablet, a laptop, a robot, a wearable device, a medical device, an unmanned aerial vehicle (UAV), or another mobile device.

In an example embodiment, the at least one processor and the memory, with the computer code instructions, may be further configured to cause the system 110 to implement a modulator 160 configured to generate at least one modulated output 106 based on the multiplexed output 128. The at least one modulated output 106 may be capable of being transmitted via at least one communications channel 124 to the receiver model 150 to produce multiple task outputs 104a-104n corresponding to the input tasks 102a-102n. The task outputs 104a-104n may represent full multiplexed execution of the ML model on the input tasks 102a-102n.

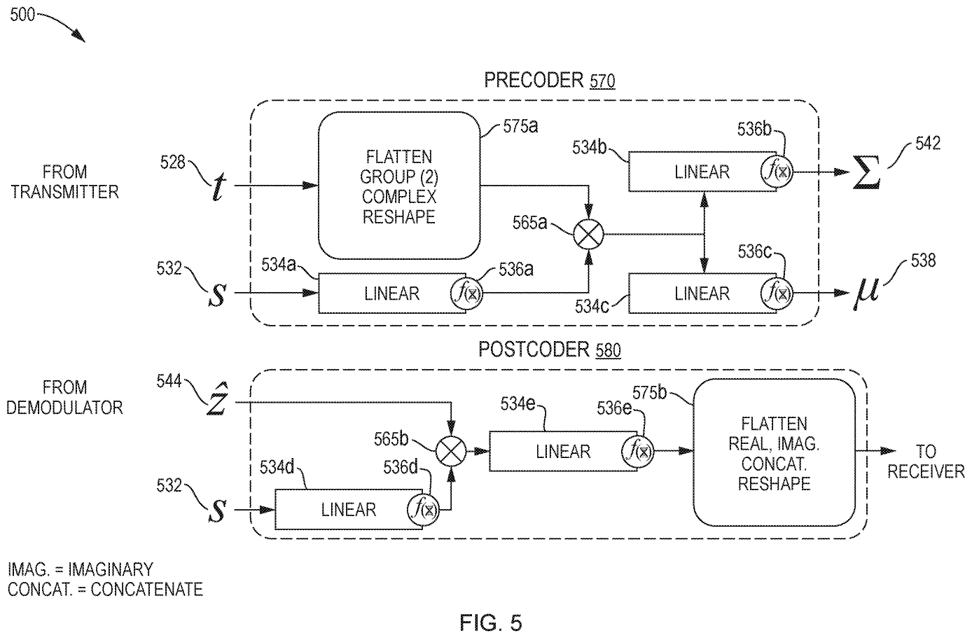

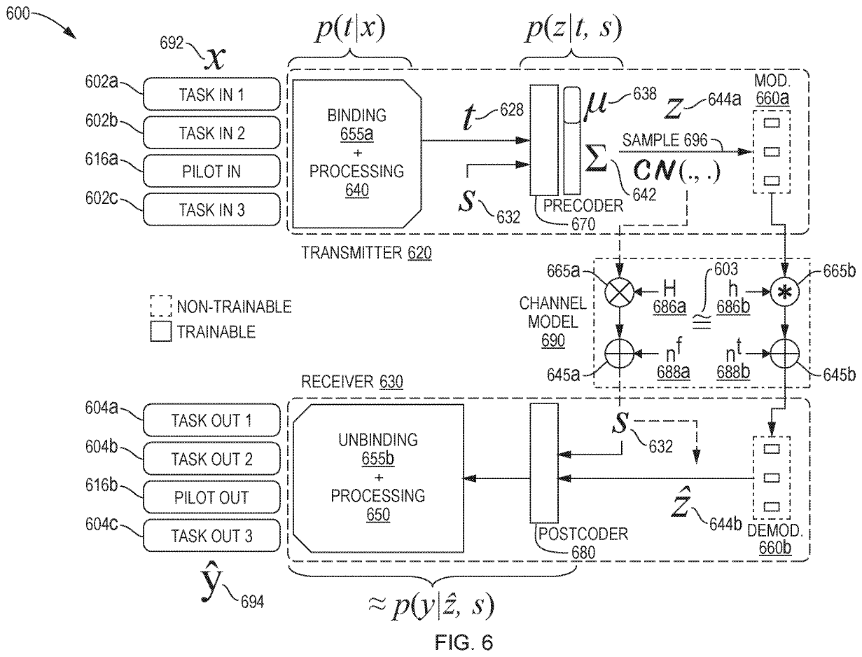

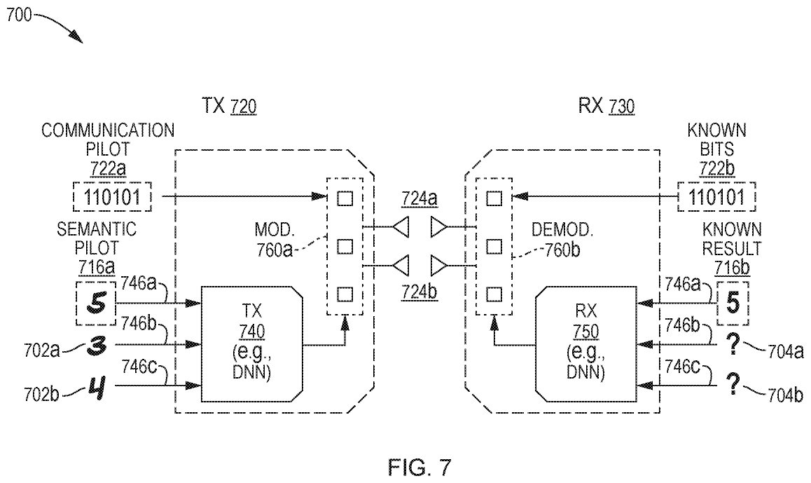

According to an embodiment, the at least one processor and the memory, with the computer code instructions, may be further configured to cause the system 110 to implement a stochastic precoding model (e.g., 370 (FIG. 3), 570 (FIG. 5), 670 (FIG. 6)) configured to transform the multiplexed output 128 into an encoded output (e.g., 644a (FIG. 6)) based on channel state information (CSI) (e.g., 532 (FIG. 5), 632 (FIG. 6)) associated with the at least one communications channel 124. In one such embodiment, the stochastic precoding model may be configured to transform the multiplexed output 128 by: (1) transforming the multiplexed output into a complex tensor (not shown); (2) computing a precoding tensor (not shown) based on the complex tensor and the CSI; and (3) generating the encoded output based on a probability distribution (not shown) associated with the computed precoding tensor. According to another such embodiment, the at least one processor and the memory, with the computer code instructions, may be further configured to cause the system 110 to dynamically determine the CSI by: (1) transmitting pilot data (e.g., 722a (FIG. 7)) to a remote system (not shown) associated with the receiver model 150 and (2) receiving the CSI from the remote system. The received CSI may be adapted to at least one condition of the at least one communications channel 124. In yet another such embodiment, the at least one processor and the memory, with the computer code instructions, may be further configured to cause the system 110 to dynamically determine the CSI by: (1) generating a pilot input (e.g., 616a (FIG. 6), 716a (FIG. 7)) based on training data associated with the ML model, the pilot input having a predetermined output (e.g., 616b (FIG. 6), 716b (FIG. 7)); (2) injecting the generated pilot input into the input tasks 102a-102n at an index (e.g., 746a (FIG. 7)) determined at least in part based on a seed value (not shown) associated with the transmitter model 140 and the receiver model 150; and (3) determining the CSI based on a difference between the predetermined output and an output of the task outputs 104a-104n at the index.

In an example embodiment, the at least one modulated output 106 may include a plurality of modulated outputs. The modulator 160 may be configured to generate the plurality of modulated outputs using a multiplexing technique. The multiplexing technique may be spatial multiplexing, time-division multiplexing, frequency-division multiplexing, or code-division multiplexing.

According to an example embodiment, the transmitter model 140 may include a first set of parameters (not shown). The receiver model 150 may include a second set of parameters (not shown). The receiver model 150 may be associated with a demodulator (e.g., 360b (FIG. 3), 660b (FIG. 6)). The at least one communications channel 124 may be associated with a channel model (e.g., 690 (FIG. 6)). The at least one processor and the memory, with the computer code instructions, may be further configured to cause the system 110 to determine the first set of parameters and second set of parameters by: (1) generating a training metric (not shown) based on a weighting metric (not shown) and probability distributions (not shown) associated with: (i) the transmitter model 140, (ii) the modulator, (iii) the channel model, (iv) the receiver model 150, and (v) the demodulator and (2) optimizing the generated training metric based on training data (not shown) associated with the ML model.

In an example embodiment, the at least one communications channel 124 may be at least one wired or wireless communications channel.

According to an example embodiment, in implementing the transmitter model 140, the at least one processor and the memory, with the computer code instructions, may be configured to cause the system 110 to partition the ML model into a pair of processing functions (not shown). The transmitter model 140 may be configured to perform the joint processing based on a first processing function of the pair of processing functions. In one such embodiment, the ML model may include a non-differentiable function (not shown). In partitioning the ML model, the at least one processor and the memory, with the computer code instructions, may be configured to cause the system 110 to (1) transform the non-differentiable function into a differentiable function (not shown) and (2) partition the differentiable function into the pair of processing functions. According to another such embodiment, in transforming the non-differentiable function, the at least one processor and the memory, with the computer code instructions, may be configured to cause the system 110 to re-parameterize the non-differentiable function.

In an example embodiment, the generated protected keys may be configured to provide corresponding protected subspaces (not shown) for processing the input tasks 102a-102n.

According to an example embodiment, in computationally binding the input tasks 102a-102n and generated protected keys, the at least one processor and the memory, with the computer code instructions, may be configured to cause the system 110 to use a holographic reduced representations (HRR) technique.

In an example embodiment, in transforming computationally bound input tasks and the generated protected keys into the compositional data structure 121, the at least one processor and the memory, with the computer code instructions, may be configured to cause the system 110 to use an element-wise summation technique (e.g., 345 (FIG. 3), 445 (FIG. 4)).

According to an example embodiment, the at least one processor and the memory, with the computer code instructions, may be further configured to cause the system 110 to implement a disjoint processing model (e.g., 415a (FIG. 4)) based on at least part of the transmitter model 140. The disjoint processing model may be configured to transform the input tasks 102a-102n into higher-dimensional representations (not shown). In one such embodiment, the higher-dimensional representations may be configured to isolate processing of the computationally bound input tasks.

### Limitations of Existing Approaches

While the goal of the first SemCom systems was the exact recovery or reconstruction of a transmitter (i.e., input) message or its semantics at a receiver (i.e., output), later systems replaced the reconstruction loss function with a task loss function to achieve task-oriented SemCom. One existing approach is a joint source and channel coding (JSCC) scheme that uses an autoencoder architecture with a noise-injection layer to model a wireless channel and train it for an image retrieval task. Another existing approach is a task-oriented SemCom system that generates discrete latent symbols to be directly modulated and transmitted as a waveform. This existing system takes an already-trained DNN and fine tunes it considering the channel distortions so that it can be brought to the physical (PHY) layer. However, the system only supports single-input single-output (SISO) communication and fails to exploit the high communication rates enabled by MIMO communication systems. Other existing approaches utilize MIMO transceivers with designs that directly reuse traditional MIMO techniques. However, such existing designs focus on communication metrics such as throughput maximization, mean-square error (MSE), and bit error rate (BER) minimization, which are inconsistent with task performance goals. An existing approach uses maximal coding rate reduction as a substitute objective for end task performance to train a MIMO system. A DNN-based algorithm is utilized to optimize linear precoding and postcoding blocks adopted in the system. However, this existing approach optimizes the wireless communication and DNN-based codecs separately. Such a design cannot achieve an end-to-end optimal system where both communication and computation are learned with the aim of successful task completion. Moreover, existing approaches are unable to multiplex computation and transmission of more computing tasks than the number of physically available channels.

As just discussed, existing task-oriented compression and communication approaches can only process a single task at a time. Traditional approaches are thus fundamentally limited by the number of physical streams currently supported by wireless standards such as Wi-Fi and 5G. As a real-world example, Vision Pro® VR headsets (Apple Inc., Cupertino, CA) are equipped with 12 cameras. Two of these cameras are for high-resolution video and generate 8K frames at 120 Hz each. This implies that 2 frames must be compressed, transmitted, and processed with an end-to-end delay of around 8 milliseconds while maintaining task accuracy. Using H.265/HEVC compression and considering 8-bit color depth, each frame occupies 4 MB, corresponding to a data rate of 4 Gbps. Existing Wi-Fi 7 networks (802.11be) offer up to 2.575 Gbps per MIMO stream only. This means that at least two streams must be dedicated to each device, thus preventing a system from being scalable.

### Overview of Example Embodiments

To address the drawbacks of existing approaches, embodiments introduce the new concept of semantic multiplexing, which includes shifting stream multiplexing from bit-level to task-level. By superposing multiple task inputs onto a single semantic representation, which is then divided between different physical streams, an example embodiment can extend the effective degrees of freedom at the semantic layer, without needing to add antennas or increase bandwidth, while still complying with Shannon capacity rules.

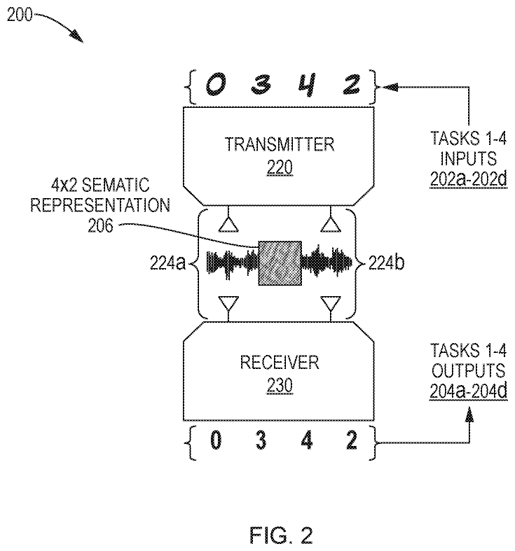

FIG. 2 is a block diagram of another example embodiment of an architecture 202200 for semantic multiplexing. As shown in FIG. 2, transmitter 220 multiplexes four tasks 202a-202d into a single semantic representation 206 that spans two physical streams 224a and 224b. At receiver 230, the representation 206 is processed to execute all the tasks 202a-202d at once and produce outputs 204a-204d.

FIG. 2 illustrates an example where four tasks 202a-202d of recognizing digits 0, 3, 4, and 2, respectively, are multiplexed and transmitted over only two communication channels 224a and 224b by superimposing the tasks' representations onto a single semantic representation 206. The representation 206 is then demultiplexed by the receiver 230 to complete the tasks 202a-202d and extract corresponding outputs 204a-204d at the same time.

### Example Semantic Multiplexing

As depicted in FIG. 2 (described hereinabove), an example embodiment semantically multiplexes multiple inputs 202a-202d for efficient transmission over wireless channels 224a and 224b. Since the semantic transmission and reception pipelines are jointly optimized, an example embodiment is independent of the number of antennas at the transmitter 220 and receiver 230. For instance, the transmitter 220 maps the task inputs 202a-202d into latent representation(s) 206 to be directly transmitted through the available antennas 224a and 224b, while the receiver 230 processes the received signal(s) 206 to obtain the task outcomes 204a-204d.

FIG. 3 is a block diagram of an example embodiment of a semantic multiplexing architecture 300 with a transmitter 320 and receiver 330. The transmitter 320 is depicted on the left side of FIG. 3. A first operation includes binding 355a task inputs 302a-302c (e.g., digit recognition tasks) using protected keys 308a-308c. This binding 355a operation ensures that each input 302a-302c is processed in a separate protected subspace thus enabling semantic multiplexing. Example binding techniques may be as described in Menet et al., “MIMONets: Multiple-Input-Multiple-Output Neural Networks Exploiting Computation in Superposition,” Advances in Neural Information Processing Systems 36 (2023), 36553-39565 (“MIMONets”), Murahari et al., “Muxplms: Data multiplexing for high-throughput language models,” arXiv preprint arXiv: 2302.12441 (2023), and Murahari et al., “DataMUX: Data Multiplexing for Neural Networks,” Advances in Neural Information Processing Systems 35 (2022), 17515-17527, which are herein incorporated by reference in their entireties. Continuing with FIG. 3, the bound key-value pairs (not shown) are summed up element-wise 345 to form a single compositional data structure that undergoes joint semantic processing 340. The latent symbol output (not shown) of the block 340 is then fed to learnable task-oriented precoding module 370, which enables quick reactions to sudden changes in a wireless channel. Based on CSI, the module 370 precodes the latent symbols by learning to optimize end task performance. Finally, a non-trainable modulator 360a generates output waveform 306. At the receiver 330 (depicted on the right side of FIG. 3), a non-trainable demodulator 360b is combined with a data-driven task-oriented postcoding module 380 and a joint semantic processing block 350 to directly process the incoming waveform(s) 306 to execute the task. The superposed task outputs 304a-304c of the block 350 are demultiplexed by performing unbinding operation(s) 355b using the corresponding keys 308a-308c.

As detailed hereinbelow, the transmitter 320 and receiver 330 are jointly trained by adding a nontrainable stochastic model that represents the communication channel. This serves to link the transmitted and received latent representations. Further details of the transmitter 320 and receiver 330 modules are provided hereinbelow.

### Example Binding and Unbinding

In an embodiment, an example binding mechanism (e.g., 355a (FIG. 3)) may employ HRR, which may be implemented using circular convolutions. An example HRR technique may be as described in Plate, “Holographic Reduced Representations,” IEEE Transactions on Neural Networks 6, 3 (1995), 623-641, which is herein incorporated by reference in its entirety. Other known binding techniques are also suitable. To continue, circular convolution may be repeatedly applied between a binding key (e.g., 308a-308c (FIG. 3)) and each input volume (e.g., 302a-302c (FIG. 3)) spanning across the feature maps. The binding may thus be translation-equivariant and may maintain locality. In contrast, an example unbinding mechanism according to an embodiment (e.g., 355b (FIG. 3)) may employ matrix binding of additive terms (MBAT), which may be implemented through matrix multiplication. An example MBAT technique may be as described in Gallant et al., “Representing Objects, Relations, and Sequences,” Neural Computation 25, 8 (2013), 2038-2078, which is herein incorporated by reference in its entirety. Other known unbinding techniques are also suitable. In an embodiment, protection keys for binding and unbinding may be initialized randomly and may be trained to mitigate interference between communication channels. For this initialization and training, an example embodiment may leverage the fact that random tensors become quasi-orthogonal as their dimension increases. Therefore, unique high-dimensional keys may be used to form quasi-orthogonal key-value pairs that can coexist and be processed concurrently. According to an embodiment, binding keys may be data-independent and may only be linked to a specific multiplexed task input (i.e., computation channel). Example binding techniques may be as described in Kleyko et al., “A survey on hyperdimensional computing aka vector symbolic architectures, part i: Models and data transformations,” Comput. Surveys 55, 6 (2022), 1-40, which is herein incorporated by reference in its entirety.

### Example Joint Processing

In an embodiment, after a binding operation, task inputs may undergo joint semantic processing at a transmitter to reduce latency and energy consumption. This transmitter joint processing operation may be modeled as a differentiable function ƒₜ(ωₜ) that processes the bound tasks toward task execution. At a receiver, joint processing may be defined as a differentiable function ƒᵣ(ωᵣ) that completes task execution before unbinding. It should be noted that if the functions are not differentiable, they may be re-parameterized as differentiable functions to be included in, e.g., joint transmitter and receiver semantic optimization through loss backpropagation as detailed hereinbelow. Example re-parameterization techniques may be as described in Jang et al., “A reparameterization-invariant sharpness measure based on information geometry,” Advances in neural information processing systems 35 (2022), 27893-27905 and Jermyn, “Invariant Bayesian estimation on manifolds” (2005), which are herein incorporated by reference in their entireties.

Both learnable and heuristic functions or models can be used with embodiments depending on the task to be executed. If learnable, these models help precoding and postcoding in generating latent representations that are robust to channel modifications and in compensating for additional channel impairments at a receiver, as discussed hereinbelow.

In an embodiment, to help task execution, two additional disjoint processing steps can optionally be integrated into an example system. At a transmitter, before binding, task inputs may undergo disjoint processing to obtain higher-dimensional representations that further help isolate the task inputs' processing once bound together. At a receiver, unbound outputs may undergo another disjoint processing step to refine the task results. Whether or not to include these optional disjoint processing steps may depend on the specific task to be executed and the computational power of a transmitter and receiver. As discussed hereinbelow, the design of an example system may account for a tradeoff between performance gains and overall system complexity.

### Example Joint Processing Functions

FIG. 4 is a block diagram of an example embodiment of a semantic multiplexing architecture 400 with a neural network 405 (e.g., DNN) for task execution. As shown in FIG. 4, the neural network model 405 is divided or partitioned into head 425 and tail 435 models corresponding to respective processing functions 440 and 450. The processing functions 440 and 450 are then deployed to or implemented at, respectively, a transmitter 420 (e.g., mobile device) and receiver 430 (e.g., edge server). A portion of the head model 425, e.g., first layer 426a, may be replicated for all inputs 402a-402c and used as optional disjoint processing function 415a prior to binding 455a and element-wise summation 445. Similarly, a portion of the tail model 435, e.g., last layer 426b, may be replicated for all outputs 404a-404c and used as optional disjoint processing function 415b following unbinding 455b.

Embodiments can be applied to a variety of tasks based on neural networks, including object detection with residual networks (ResNets) and text analysis with transformer networks, for non-limiting examples. As depicted in FIG. 4, the neural network model 405 responsible for task execution can be divided into two differentiable and learnable processing functions 440 (ƒₜ(ωₜ)) and 450 (ƒᵣ(ωᵣ)), which may then be deployed at, respectively, the transmitter 420 and receiver 430. At the transmitter 420, a portion of the head model 425, e.g., the first layer 426a, can also be replicated for all inputs 402a-402c and used as the disjoint preprocessing function 415a that helps the binding mechanism 455a. At the receiver 430, a similar strategy can be applied by isolating and replicating the last layer(s) 426b for the final processing step 415b on the unbound 455b outputs to obtain the task results 404a-404c. For example, in a classification task, the last linear (classifier) layer can be used for the processing step 415b.

It should be noted that embodiments are not limited to neural networks such as DNNs and that other known ML models are also suitable.

### Example Precoding and Postcoding

In an embodiment, optional precoding and postcoding allow quick responses to channel variations while maintaining suitable task performance.

An example embodiment may implement a learnable stochastic precoder instead of using deterministic models, because the latter may result in a latent space where closer points do not necessarily associate with closer points in the task output space. And because deterministic models memorize an exact mapping between the latent space and the output space, a small perturbation of the latent space—whether intentional (e.g., adversarial) or unintentional (e.g., channel distortions)—can change the task result drastically. Conversely, using a stochastic precoder with a customized loss function (described hereinbelow) allows an example embodiment to impose a prior distribution on latent symbols, thereby increasing generalization ability. It should be noted, however, that embodiments are not limited to stochastic models and that deterministic models are also suitable. According to an embodiment, a deterministic model may be used for a learnable postcoder to simplify the formulation.

Discussed below are three non-limiting example techniques for implementing a precoder and/or postcoder:
a) One technique entails conditioning the entire transmitter processing function on the CSI, i.e., defining the function as ƒₜ(ωₜ|s) to process the bound task inputs. However, this increases the processing function complexity (e.g., input layer size if a DNN is used as the processing function). The result is high computation overhead on the transmitter, which may be an energy-constrained mobile device.
b) Another technique entails adding a further processing function (e.g., a separate neural network) to the transmitter to jointly process (i) the output of the bound input processing (i.e., through function ƒₜ(ωₜ)) and (ii) the CSI. While this leaves the original transmitter function ƒₜ(ωₜ) intact, it still leads to an increase in the transmitter computation load.
c) Yet a further technique entails using a dedicated precoding module that processes the CSI separately, computes a task-oriented precoding tensor, and uses the precoding tensor to transform processed latent symbols to compensate for channel distortion. This enables balancing representational power with reduced computation load. In an embodiment, a precoding module may be implemented using any suitable known technique, such as Zero-Forcing (ZF) precoding or Linear Minimum Mean Squared Error (LMMSE) precoding, for non-limiting examples.

FIG. 5 is a block diagram of an example embodiment of a semantic multiplexing architecture 500 with an optional precoder 570 and postcoder 580.

The precoder 570 structure is depicted at the top of FIG. 5. As further detailed hereinbelow, in an embodiment, the conditional probability of latent symbols (not shown) for a given input may be modeled with a complex Gaussian distribution, and processing at a transmitter ƒₜ(ωₜ) combined with the precoder 570 may be used to extract the mean 538 and covariance 542 of this distribution.

As shown in FIG. 5, tensor t 528 denotes bound and processed inputs obtained from the transmitter ƒₜ(ωₜ). Because the precoder 570 processes complex in-phase/quadrature (I/Q) symbols, the tensor 528 is converted 575a to a complex tensor (not shown) using the first part as the real part and the second part as the imaginary parts. In an embodiment, the conversion 575a may include a “Flatten” operation to convert a M×N×P tensor to an M*N*P×1 array by flattening out its dimensions, a “Group (2)” operation to break the array/tensor into two chunks (parts), and/or a “Reshape” operation to change the shape/dimensions of the tensor while the total number of elements/entries remains fixed. Continuing with FIG. 5, the resulting converted 575a tensor is split into multiple packets (not shown). CSI 532, denoted by s, is fed to a linear layer 534a with non-linear activation 536a to compute a semantic precoding tensor (not shown) for each packet. After applying precoding, e.g., via matrix multiplication 565a, the packets (not shown) are fed to two other linear heads 534b and 534c with respective non-linear activations 536b and 536c to extract the mean 538 (μ) and covariance 542 (Σ). The latent symbols are generated by sampling a Gaussian distribution with the parameters 538 and 542. The latent symbols are then passed to a modulator (not shown) to generate waveforms ready to be transmitted.

The postcoder 580 structure is depicted at the bottom of FIG. 5. Similar to the precoder 570, the postcoder 580 calculates a semantic postcoding tensor (not shown) for each antenna by processing the CSI 532 through a learnable linear transformation 534d with a non-linear activation function 536d. Corrupted latent symbols 544 are postcoded using this tensor, e.g., via matrix multiplication 565b, processed through another linear layer 534e with a non-linear activation 536e, converted 575b to real-valued feature maps (not shown) and fed to a receiver processing block (not shown) including joint processing ƒᵣ(ωᵣ), unbinding, and optional disjoint processing to obtain task outcomes. In an embodiment, the conversion 575b may include a “Flatten” operation to convert a M×N×P tensor to an M*N*P×1 array by flattening out its dimensions, a “Concat.” operation to concatenate two tensors into a single tensor, and/or a “Reshape” operation to change the shape/dimensions of the tensor while the total number of elements/entries remains fixed.

### Example Modulation and Demodulation

In an embodiment, at a transmitter, an example modulator may take latent symbols (e.g., from a precoder) in the frequency domain and transform them to time-domain baseband symbols. The baseband symbols may in turn be up-converted to a carrier frequency and transmitted via, e.g., a radio frontend. Conversely, received waveforms may be down-converted to I/Q samples and further transformed to frequency-domain symbols by an example demodulator. According to an embodiment, transmission of latent symbols can be modeled by first performing a matrix multiplication between (i) the latent symbols input to a modulator in the frequency domain (f) and (ii) the channel frequency response (CFR), then applying noise to generate distorted latent symbols as the output of a demodulator. In an embodiment, an example modulator and demodulator may be implemented with direct and inverse fast Fourier transform (FFT) techniques, respectively. Other known techniques are also suitable.

### Example Optimization

An example system according to an embodiment may be jointly trained to enable task-oriented precoding and postcoding that jointly optimize communication and computation objectives. This represents an example of a technical improvement provided by embodiments. In contrast, existing approaches separately optimize communication and computation, which results in a suboptimal system that lacks semantic multiplexing capabilities (e.g., the existing MCR2/sm baseline approach described hereinbelow). Detailed hereinbelow is a new information-theoretical framework that enables combined training of all learnable blocks in an example embodiment. An example innovation offered by embodiments is a system integrated with a channel model that captures how signals are modified during wireless propagation. A complete probabilistic model may be derived and a loss function may be formulated to jointly train modules according to an example embodiment. Detailed hereinbelow are example techniques according to an embodiment for dynamically adapting a system to compensate for changing wireless channel(s).

FIG. 6 is a block diagram of an example embodiment of a probabilistic system model 600 for semantic multiplexing. As shown in FIG. 6, transmitter 620 includes binding operation 655a and joint semantic processing block 640, which are indicated as trainable by a solid line. In an embodiment, task input data 692 may include task inputs 602a-602c and pilot input 616a. The transmitter 620 applies the binding 655a to the input data 692, followed by the processing 640. In turn, processing output representation 628 produced by the block 640 is fed to a trainable precoding module 670 (indicated by a solid line). The module 670 determines parameters 638 and 642 based on CSI 632 for communications channel(s) (not shown) and the representation 628. A distribution with the parameters 638 and 642 is then sampled 696 to generate latent symbols 644a. Based on the latent symbols 644a, non-trainable modulator 660a (indicated by a dashed line) generates output waveform(s) (not shown).

Continuing with FIG. 6, the communications channel(s) are represented by non-trainable channel model 690 (indicated by a dashed line). The model 690 represents the CSI 632 with CFR matrix in the frequency domain H 686a and a variance vector (not shown), the latter of which is used to generate noise in the frequency domain n^{f} 688a. In an embodiment, the latent symbols 644a are multiplied 665a by the CFR matrix 686, followed by adding 645 the noise 688a to generate corrupted latent symbols 644b. According to another embodiment, the product 665a of the frequency-domain CFR matrix 686a summed with the frequency-domain noise 688a may be considered equivalent 603 to a product 665b of time-domain (t) CFR matrix h 686b summed with time-domain noise n^{t} 688b.

Continuing with FIG. 6, receiver 630 includes non-trainable demodulator 660b (indicated by a dashed line), which processes incoming waveform(s) (not shown). The corrupted symbols 644b are then fed to a trainable postcoding module 680 (indicated by a solid line). The postcoder 680 generates a result (not shown) based on the corrupted symbols 644b and the CSI 632. In turn, the result is subject to joint semantic processing 650 followed by unbinding 655b (both indicated as trainable by a solid line) to produce output data 694. According to an embodiment, the output data 694 may include task outputs 604a-604c corresponding to the task inputs 602a-602c and pilot output 616b corresponding to the pilot input 616a.

An example probabilistic model 600 is illustrated in FIG. 6. In an embodiment, the task input data x 692 and corresponding desired outputs y may be generated by an information source having an underlying joint probability distribution p(x, y). The latent symbols 644a may be a frequency-domain input to the modulator 660a. An example embodiment may leverage information theory principles to generate the symbols 644a so as to contain only the information needed to complete a task and obtain y at the receiver 630. The extraction of such symbols z 644a from the inputs x 692 and conditioned on the CSI s 632 for a given packet p and subcarrier k, may be modeled as sampling from conditional probability p(z_{p,k}|x, s). This probability may be modeled as a Gaussian distribution with the parameters μ 638 and Σ 642, which are determined by combining the transmitter processing 640 together with the precoder 670 (e.g., a stochastic precoder as described hereinabove). Other known distributions are also suitable. To reduce the computational load, an example embodiment may adopt the mean-field principle that the conditional probabilities for different packets p and subcarriers k in the latent symbols z 644a are independent. The mean-field principle is commonly used in multi-carrier MIMO systems, where each packet and subcarrier is processed independently. According to an embodiment, using the mean-field principle, p(z|x, s) may be represented as follows:

$$p ( z \vert x , s ) = {\prod }_{p = 1}^{P} {\prod }_{k = 1}^{K} p ( {z}_{p , k} \vert x , s )$$

In an embodiment, the combined transmitter processing ƒₜ(ωₜ) 640 and precoder 670 may implement the below functions to determine the parameters μ 638 and Σ 642, respectively, for a given packet p and subcarrier k:

$${f}_{p , k}^{μ} ( x , s ; ϕ )$$

$${f}_{p , k}^{\sum } ( x , s ; ϕ )$$

where φ denotes learnable parameters.

According to an embodiment, p(z|x, s) may then be represented as follows:

$$p ( z \vert x , s ) = {\prod }_{p = 1}^{P} {\prod }_{k = 1}^{K} 𝒞𝒩 ( {f}_{p , k}^{μ} ( x , s ; ϕ ) , {f}_{p , k}^{\sum } ( x , s ; ϕ ) ) . \qquad ( 1 )$$

In an embodiment, the conditional probability p(z_{p,k}|x, s) may be approximated over two phases. First, the transmitter 620 may determine p(t|x) conditioned on the inputs 692, where t is the processing output representation 628. Second, the precoder 670 may implement p(z_{p,k}|t, s) conditioned on t 628 and the CSI s 632 to obtain the following:

p(z_{p,k}|x,s)=∫p(z_{p,k}|t,s)p(t|x)dt

After deployment, the transmitter 620 may modulate 660a the symbols z 644a sampled from p(z|x, s) and transmit the waveform(s) over the channel.

The receiver 630 may collect the distorted signals and demodulate 660b them into the corrupted latent symbols \hat{z} 644b, which are then fed to the postcoder 680 in conjunction with the receiver processing block ƒᵣ(ωᵣ) 650 to finalize task inference and compute the results ŷ 694 using the example function g (\hat{z}, s; θ), where θ denotes learnable parameters. The prediction of the task outputs y from the corrupted latent symbols \hat{z} 644b and conditioned on the CSI s 632 may be modeled as sampling from a conditional probability p(y|\hat{z}, s).

### Example Wireless Channel Model

During training, an example embodiment may use the model 690 (e.g., a stochastic model) for signal propagation and may represent the wireless channel between the transmitter 620 and receiver 630 in a frequency domain. In an embodiment, the model 690 may account for different numbers of antennas (e.g., one or multiple) at the transmitter 620 and the receiver 630. According to an embodiment, the model 690 may implement frequency-selective multi-path fading effects (based on, e.g., Rayleigh and/or Rician distributions) as well as an additive complex white Gaussian noise. Other known distributions and noise are also suitable.

In an embodiment, the CSI s 632 modeling the channel may include both the CFR matrix H 686a and the noise variance vector σ² in the frequency domain. As shown in FIG. 6, the latent symbols 644a produced by the transmitter 620 may be multiplied 665a by the CFR H 686a. The noise n^{f} 688a may then be sampled from a circularly symmetric complex Gaussian distribution according to ~ [symbol] [symbol] (0,σ²) and added 645 to generate the corrupted latent symbols 644b. To account for constraints on the transmitter power, we normalize the peak power of the modulated signal to 1, resulting in a signal-to-noise ratio (SNR) of

$$10 {log}_{10} \frac{1}{{σ}^{2}} .$$

The modulator. 660a, demodulator 660b, and channel model 690 may be non-trainable yet differentiable layers during the end-to-end training of an example embodiment, and may be modeled by equivalent conditional distribution p(\hat{z}|z, s).

An example embodiment may account for wireless transmission where latent representations are transmitted as PHY layer waveforms. Thus, latent symbols collected at a receiver (e.g., 630) may be channel-distorted versions (e.g., 644b) of the transmitted representation (e.g., 644a). During end-to-end training (described hereinbelow), an example embodiment may identify distortion patterns caused by a channel and learn a custom channel coding technique that robustifies latent features against distortion patterns. An example embodiment may thus perform channel coding in addition to a processing task.

### Example Loss Function Formulation

As discussed hereinabove, an example embodiment may leverage information theory principles to learn a random variable Z (i.e., latent representation) that captures only task-relevant information from random variable X (i.e., input data) to predict random variable Y (i.e., output results) at a receiver. An example embodiment may thus leverage information bottleneck (IB) principles to formulate a loss function [symbol] for training as follows:

$${ℒ}_{IB} = - I ( \hat{Z} ; Y \vert s ) + β \cdot I ( X ; Z \vert s ) = {𝔼}_{p ( x , y )} \{ {𝔼}_{p ( s )} \{ {𝔼}_{p ( \hat{z} \vert x , s )} [ - log p ( y \vert \hat{z} , s ) ] + β \cdot {D}_{KL} ( p ( \hat{z} \vert x , s ) ‖ p ( z ) ) \} \} - H ( Y ) , \qquad ( 2 )$$

where:
0≤β≤1 is the weight controlling the efficiency-performance tradeoff
I(Ź; Y|s) is the conditional mutual information between 2 and X given CSI s
I(X;Z|s) is the conditional mutual information between X and Z given CSI s
[symbol] is the expectation over joint samples (x, y)
[symbol] is the expectation over samples of s
[symbol] is the expectation over the conditional distribution of \hat{z} given x and s
D_{KL}(p(\hat{z}|x,s)∥p(z)) is the Kullback-Leibler (KL) divergence between the conditional distribution p(\hat{z}|x, s) and the probability distribution p(z)
H(Y) is the entropy of variable Y

IB principles may be as described in Tishby et al., “The information bottleneck method,” arXiv preprint physics/0004057 (2000), which is herein incorporated by reference in its entirety.

By minimizing the above example loss function [symbol] , an example embodiment may force Z to forget the unnecessary information in X by minimizing I(X; Z|s), and to retain only the minimal sufficient statistics of X for expressing Y by maximizing I(Ź; Y|s). As a result, an example embodiment can find the optimal Z that is maximally compressive for X while being maximally predictive for Y.

Described hereinbelow is an example derivation of an approximation of the loss function in Equation (2) above that can be effectively implemented to jointly train modules according to an embodiment.

### Example Variational Upper Bound Reformulation

The conditional distribution p(\hat{z}|x, s) in example Equation (2) above may be derived by p(\hat{z}|x, s)=∫p(z|x, s)p(\hat{z}|z, s)dz, where p(z|x, s) is derived in example Equation (1) above. However, computing the remaining distributions p(z) and p(y|\hat{z}, s) for high-dimensional data with arbitrary distributions is computationally prohibitive. To overcome this issue, an example embodiment may leverage the variational IB (VIB) principle to obtain a variational upper bound of the loss. The VIB principle may be as described in Alemi et al., “Deep Variational Information Bottleneck,” arXiv preprint arXiv: 1612.00410 (2016), which is herein incorporated by reference in its entirety.

In an embodiment, variational distributions q(z) and q(y|\hat{z}, s) may be defined to approximate p(z) and p(y|\hat{z}, s), respectively. For instance, a postcoder together with a receiver processing block may be used as a variational approximation of p(y|\hat{z}, s). The type of this conditional probability p(y|\hat{z}, s) may depend on the task. For example, for classification tasks, the conditional probability may have a categorical distribution, and the distribution parameters may be determined using a postcoder together with a receiver processing block. Using this approximation, the variational upper bound of the first term in example Equation (2) above may be derived as follows:

$${𝔼}_{p ( x , y )} \{ {𝔼}_{p ( \hat{z} \vert x , s )} [ - log p ( y \vert \hat{z} , s ) ] \} = {𝔼}_{p ( x , y )} \{ {𝔼}_{p ( \hat{z} \vert x , s )} [ - log q ( y \vert \hat{z} , s ) ] \} - {\underbrace{{𝔼}_{p ( \hat{z} )} \{ {𝔼}_{p ( y \vert \hat{z} , s )} [ log \frac{p ( y \vert \hat{z} , s )}{q ( y \vert \hat{z} , s )} ] \}}}_{{D}_{KL} ( p ( y \vert \hat{z} , s ) ‖ q ( y \vert \hat{z} , s ) ) \geq 0} \leq {𝔼}_{p ( x , y )} \{ {𝔼}_{p ( \hat{z} \vert x , s )} [ - log q ( y \vert \hat{z} , s ) ] \}$$

Similarly, the variational upper bound for the second term in example Equation (2) above may be computed as:

$${D}_{KL} ( p ( z \vert x , s ) ‖ p ( z ) ) = {D}_{KL} ( p ( z \vert x , s ) ‖ q ( z ) ) - {\underbrace{{D}_{KL} ( p ( z ) ‖ q ( z ) )}}_{\geq 0} \leq {D}_{KL} ( p ( z \vert x , s ) ‖ q ( z ) )$$

Because minimizing the above upper bound minimizes the KL divergence between p(z|x, s) and q(z), a variational prior q(z) can be imposed to induce that prior distribution on latent symbols. Therefore, to regularize (i.e., sparsify) the latent space during training and prevent an example embodiment from memorizing an exact mapping, a complex normal prior distribution, i.e., q(z)~ [symbol] [symbol] (0,I), may be used. Other known distributions are also suitable.

The variational upper bound of the loss function in example Equation (2) above may ultimately be derived as:

[symbol]

= [symbol] { [symbol] { [symbol] [−log q(y|\hat{z},s)]+β·D_{KL}(p(z|x,s)∥ [symbol] [symbol] (0,I))}}. (3)

In an embodiment, when p(z|x, s) is Gaussian and the KL divergence between two complex Gaussian distributions has a closed form expression, the second term in example Equation (3) above can be computed analytically.

### Example Loss Function Estimation

In an embodiment, Monte Carlo sampling can be used to obtain an unbiased estimate of the expected values in example Equation (3) above. Other known sampling techniques are also suitable. Semantic Multiplexing is trained using a gradient descent algorithm on the estimated loss. It should be noted that a precoder output may be a distribution p(z_{p,k}|t, s), which may be sampled to obtain a realization. However, such sampling may not be differentiable. Thus, a re-parameterization technique may be used to make an example embodiment trainable through loss backpropagation. An example re-parameterization technique may be as described in Kingma et al., “Auto-encoding variational bayes” (2013), which is herein incorporated by reference in its entirety. For instance, given a mini-batch of

$${N}_{mb} \times {N}_{comp} data points {\{ ( xi , yi ) \}}_{i = 1}^{{N}_{mb} \times {N}_{comp}} ,$$

where N_{mb} is the batch size and N_{comp} is the number of multiplexed task inputs, N_{comp} inputs x may be fed to a transmitter processing block together with a precoder, and Gaussian distribution parameters may be obtained for latent symbols in each packet and subcarrier z_{p,k}. Then, N_{mc} realizations of latent symbols z may be sampled using these distributions, where N_{mc} is the number of Monte Carlo samples. N_{mc} realizations of CFR and N_{mc} realizations of channel noise n^{f} may also be sampled to define N_{mc} realizations of CSI s. An example loss function according to an embodiment may thus be estimated as follows:

$${\tilde{ℒ}}_{VIB} = \frac{1}{{N}_{mb}} {\sum }_{{n}_{mb} = 1}^{{N}_{mb}} \{ \frac{1}{{N}_{mc}} {\sum }_{{n}_{mc} = 1}^{{N}_{mc}} [ - log q ( {y}_{{n}_{mb}} \vert {\hat{z}}_{{n}_{mb} , {n}_{mc}} ) + β \cdot {\sum }_{p = 1}^{P} {\sum }_{k = 1}^{K} {D}_{KL} ( p ( {z}_{{n}_{mb} , {n}_{mc} , p , k} \vert {x}_{{n}_{mb}} , {s}_{{n}_{mc}} ) ‖ 𝒞𝒩 ( 0 , I ) ) ] \} , \qquad ( 4 )$$

$$where {\hat{z}}_{{n}_{mb} , {n}_{mc}} = {H}_{{n}_{mc}} {z}_{{n}_{mb} , {n}_{mc}} + {n}_{mc}^{f} .$$

### Example Dynamic Adaptation

FIG. 7 is a block diagram of an example embodiment of a semantic multiplexing architecture 700 with communication and semantic channel sounding. As shown in FIG. 7, for communication sounding, pilot symbols 722a (or reference signals) are inserted into an outgoing signal of transmitter 720. CSI for communication channel(s) 724a and 724b (e.g., wireless channels) used by modulator 760a and demodulator 760b is then determined by comparing an incoming value of the pilot symbols at receiver 730 with a known value 722b. In contrast, for semantic (or computation/task-oriented) sounding, computation channel 746a of transmitter model 740 (e.g., a head DNN) is randomly selected for semantic pilot 716a, while remaining channels 746b and 746c are used for task inputs 702a and 702b, respectively. The CSI is then determined by comparing an output of receiver model 750 (e.g., a tail DNN) on computation channel 746a with a known result 716b. The remaining channels 746b and 746c of the receiver model 750 produce task outputs 704a and 704b, respectively.

After deployment and during testing, an example embodiment may alternate between two different techniques to sound a wireless channel and adapt to changing conditions as illustrated in FIG. 7 and described hereinbelow. The first technique leverages communication procedures, while the second technique is specifically designed for a semantic multiplexing framework and has never been realized before.

### Example Communication Pilots Transmission

Before performing inference, an example embodiment may employ a wireless channel sounding procedure designed for precoding in MIMO networks. For instance, a mobile device may transmit a packet containing pilot symbols (e.g., 722a) only. By comparing the received pilot symbols against their expected value (e.g., 722b), an edge server may estimate CSI and feed it back to the mobile device. In an embodiment, the estimated CSI may be used by precoding and postcoding to adapt to a varying wireless channel (e.g., 724a and 724b).

### Example Task-Oriented Pilots Processing

During normal operation mode, an example embodiment may randomly select a computation channel (e.g., 746a) to process task-oriented pilots (e.g., 716). It may be required for a transmitter (e.g., 720) and receiver (e.g., 730) to stay synchronized in selecting the index of such a computation channel. In such a case, an example embodiment may utilize a hash function to determine the index based on, e.g., the global time and a preestablished seed value that is shared between the transmitter and receiver without requiring explicit communication. Other known functions are also suitable. The transmitter may use the selected channel to process an input (e.g., 716a) with a known task output (e.g., 716b). In an embodiment, a transmitter device (e.g., a mobile device) may utilize a small subset of its training inputs as task-oriented pilots, but the subset may be determined such that it does not unduly burden the limited storage capacity of a mobile device. According to an embodiment, because a task result (e.g., 716b) of a selected computation channel (e.g., 746a) may be known by an edge server, the corresponding loss can be calculated and backpropagated through that channel.

In view of the discussion hereinabove, transmitter and receiver models (e.g., 740 and 750, such as DNNs, etc.) can be adapted in an end-to-end manner that accounts for an updated MIMO channel model by using CSI estimated through communication pilots (e.g., 722a). An inference-time adaptation technique according to an embodiment can maintain isolation between different computation and communication channels.

### Example Prototype

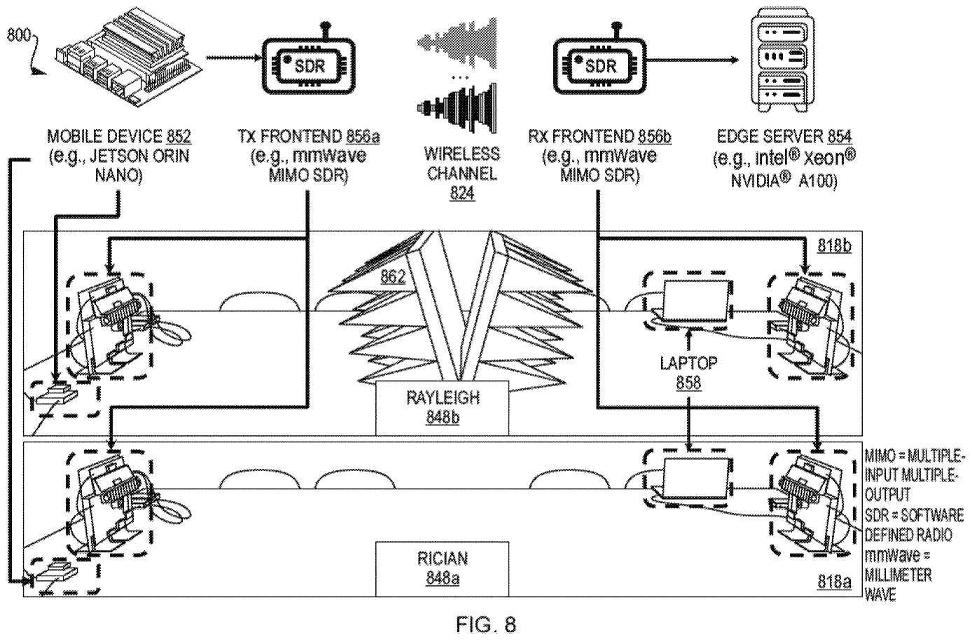

FIG. 8 is a composite image of an example embodiment of an experimental setup 800 for real-world evaluation of semantic multiplexing in a conference room in line-of-sight (LoS) 818a and non-line-of-sight (NLoS) 818b scenarios. The top of FIG. 8 illustrates an end-to-end prototype according to an embodiment that includes a mobile device 852 and edge server 854, which communicate over wireless channel 824 via transmitter 856a and receiver 856b frontends, respectively. It should be noted that the edge server 854 may be a laptop 858 or any other suitable known computing device. As shown at the bottom of FIG. 8, the prototype was deployed to the conference room and experiments were conducted with absorbers 862 in the NLOS scenario 818b, corresponding to Rayleigh fading 848b, and without the absorbers 852 in the LoS scenario 818a, corresponding to and Rician fading 848a.

An end-to-end prototype according to an embodiment was developed as illustrated in the upper part of FIG. 8. A Jetson Orin Nano board powered by a 32-tensor-core NVIDIA® Ampere GPU and a 6-core ARM® Cortex®-A78AE CPU was used as the mobile device 852, which may be energy-constrained, to implement a transmitter. A workstation equipped with a 432-tensor-core NVIDIA A100 GPU and a 12-core Intel® Xeon® Silver 4410Y CPU was used as the edge server 854 to implement a receiver. Other known computing device configurations are also suitable. Millimeter-wave (mmWave) SDRs were used as the transmitter 856a and receiver 856b frontends. The SDRs operate at 60 GHz with a bandwidth of 1 GHz and each is equipped with 8 digitally controlled RF chains, thus supporting fully digital 8×8 mmWave communications. Other known radio configurations are also suitable. The Nano board was connected to the transmitter radio 856a while the workstation was connected to the receiver radio 856b. The prototype was deployed in a conference room, as shown at the bottom of FIG. 8. Experiments were conducted both with and without the absorber foams 862 placed at a 1.5 m distance from the radios 856a and 856b, corresponding to the NLOS scenario 818b with Rayleigh fading 848b and the LoS scenario 818a with Rician fading 848a, respectively.

In an embodiment, during training, a SNR of, e.g., 20 dB, may be used to determine additive noise variance in the probabilistic model, while CFR may be collected from the experimental setup 800 and changed at every epoch. An orthogonal frequency division multiplexing (OFDM) modulation scheme may be incorporated with an FFT size of, e.g., 724, using, e.g., 800, out of 724 subcarriers and leaving the rest unused as guard bands. Other known modulation schemes are also suitable. A rectified linear unit (ReLu) activation function may be used as a non-linear activation function in a precoder and postcoder. Other known activation functions are also suitable. The tradeoff parameter in Equation 1 (described hereinabove) may be set to, e.g., β=10⁻⁴.

According to an embodiment, during testing and adaptation, system parameters (e.g., all parameters) may be frozen, except for, e.g., precoding and postcoding parameters, as well as binding and unbinding keys.

### Example Processing Tasks

An example embodiment was tested with image classification and sentiment analysis tasks to evaluate the effectiveness of semantic multiplexing on different input types—i.e., images and text, respectively- and using different processing functions—i.e., ResNets and transformers, respectively.

In keeping with existing studies, an example embodiment was evaluated for image classification tasks using the Canadian Institute for Advanced Research (CIFAR)-10, CIFAR-100, and Street View® House Numbers (SVHN) datasets. CIFAR-10 and CIFAR-100 each contain 50,000 training images and 10,000 testing images, distributed evenly among 10 and 100 classes, respectively. SVHN includes 73,257 training images and 26,032 testing images across 10 classes. All datasets have RGB input channels. Data augmentation was consistently applied to the training set through random horizontal flips, random cropping, and normalization. Other known data augmentation techniques are also suitable. WideResNet (WRN) DNNs were selected for image classification; other known models are also suitable. Specifically, the WRN-28-10, WRN-16-8, and WRN-10-4 learning models were selected. The first and second numbers in each model name indicate the depth (i.e., number of layers) and width (i.e., number of kernels) of the model. For instance, WRN-28-10 has a depth of 28 and a width of 10. The larger architectures provide improved performance at the cost of increasing computational and memory load. As depicted in FIG. 4, for each model, the backbone was divided after the first ResNet block and the one-block head DNN (e.g., 425) was deployed as joint processing function ƒₜ(ωₜ) (e.g., 440) on a mobile device (e.g., 420), while the remaining tail DNN (e.g., 435) was deployed as joint processing function ƒᵣ(ωᵣ) (e.g., 450) at an edge server (e.g., 430).

An example embodiment was evaluated for text sentiment analysis tasks according to the Long-Range Arena (LRA) benchmark for transformers. The IMDb® dataset, which contains 50,000 movie reviews, was used for binary sentiment classification. The IMDb training and testing sets each consist of 25,000 highly polarized movie reviews. A transformer model was used as a signal processing function for sentiment classification. A transformer architecture consisting of 6 attention blocks with 8 heads each may be as described in MIMONets, which is herein incorporated by reference in its entirety. Other known transformer architectures are also suitable. This architecture presents an additional challenge with respect to WRN DNNs, because binding and unbinding processes may need to be performed sequentially for each of the 6 attention blocks to enable task multiplexing. A sequence beginning at the first attention block and ending at a multi-layer perceptron before the unbinding process for the first block was deployed at a transmitter, while the unbinding process and remaining attention blocks were deployed at a receiver.

For both the image classification and sentiment analysis tasks, at the transmitter, the first convolutional layer was cloned for each task input as a preliminary disjoint processing block to improve separation in the semantic space enforced by the binding mechanism. At the receiver, the last linear (classifier) layer was duplicated for all outputs. Each classifier was fed with one of the unbound values and returned the associated task result.

### Existing Baseline Approaches

Four existing baseline approaches were evaluated. The baselines are discussed herein using the naming convention “BaselineName/xy”, where ‘x’ and ‘y’ identify each baseline's computation and communication approach, respectively. An approach is either multiplexed (‘m’) or nonmultiplexed (‘s’). Notably, embodiments provide the first ever techniques for multiplexing both computation and communication. The baselines are described hereinbelow by grouping them into two categories. The first category includes approaches that use SemCom at the application layer and transmit data using a full protocol stack, while the second category includes approaches that directly generate PHY representations.

### Full-Stack SemCom Baselines

Existing full-stack SemCom approaches use IEEE 802.11 (Wi-Fi) to transfer latent representations. Specifically, latent floating-point features for each batch of images are converted into their bit representations and divided into application layer protocol data units (PDUs) based on a suitable maximum transmission unit (MTU) size. The PDUs are encapsulated using transmission control protocol (TCP) and the Wi-Fi data link layer to form PHY-layer bits. The I/Q symbols are generated using a quadratic phase-shift keying (QPSK) modulation scheme and fed to an OFDM block to be further transmitted using a radio. The retransmission mechanisms employed at different layers of the protocol stack allow these approaches to maintain performance with different communication channel conditions, at the cost of increasing end-to-end latency and mobile energy consumption. The following two full-stack SemCom baselines were evaluated:
a) MNet/ms: First, MIMONets was used to build MIMO-DNNs based on WRNs. Each DNN was then divided between a transmitter and receiver by applying the approach described in Kang et al., “Neurosurgeon: Collaborative Intelligence Between the Cloud and Mobile Edge,” ACM SIGARCH Computer Architecture News 45, 1 (2017), 615-629, which is herein incorporated by reference in its entirety. The first layer of each DNN was deployed on the transmitter, while the rest was executed on the receiver.
b) BF/ss: The BottleFit approach is described in Matsubara et al., “BottleFit: Learning Compressed Representations in Deep Neural Networks for Effective and Efficient Split Computing,” in Proceedings of IEEE International Symposium on a World of Wireless, Mobile and Multimedia Networks (WoWMoM) (2022), which is herein incorporated by reference in its entirety. BottleFit reduces the amount of data transferred while learning a compressed latent representation in single-input DNNs by decreasing the width of the last convolutional layer in the first WRN block and other affected layers. A two-stage training procedure based on knowledge distillation (KD) is used in BottleFit to compensate for decreases in accuracy. BF-9/ss and BF-3/ss refer to the same approach using 9 and 3 kernels as the reduced width, respectively.

### PHY Layer SemCom Baselines

In existing PHY layer SemCom approaches, the latent symbols are already channel-encoded. The packet detection and synchronization were implemented similarly to Wi-Fi. These existing approaches implicitly compensate for channel impairments regardless of wireless conditions and without relying on retransmissions. The following two PHY layer SemCom baselines were evaluated:
a) MCR2/sm: A MIMO SemCom system using linear precoding and postcoding blocks similar to those in traditional communication systems, which are iteratively updated, is described in Cai et al., “Multi-Device Task-Oriented Communication via Maximal Coding Rate Reduction,” IEEE Transactions on Wireless Communications 23, 12 (2024), 18096-18110, and Cai et al., “End-to-End Learning for Task-Oriented Semantic Communications Over MIMO Channels: An Information-Theoretic Framework,” IEEE Journal on Selected Areas in Communications (2025), which are herein incorporated by reference in their entireties. Class-wise separability was adopted as a surrogate measure for classification accuracy. The entire DNN up to the penultimate layer was executed at a transmitter, which sends only class probabilities to a receiver. While the underlying implementation is based on fixed CSI, it was modified to use adaptive CSI for evaluation purposes, thereby establishing a fair comparison with embodiments.
b) PhyDNN/ss: The PhyDNN approach is described in Abdi et al., “PhyDNNs: Bringing Deep Neural Networks to the Physical Layer,” Proceedings of IEEE International Conference on Computer Communications (INFOCOM) (2025), which is herein incorporated by reference in its entirety. PhyDNN can transform a pretrained AI/ML model (e.g., DNN) and give it the ability to be deployed directly in the PHY layer. For example, the transformation may include introducing a codebook into the model to produce discrete latent symbols compatible with a given modulation scheme. This approach was utilized as a baseline by applying it to WRN models to generate OFDM symbols at the output of the initial layers.

### Example Results

Described hereinbelow are results of evaluating the performance of an example embodiment (referred to hereinbelow as “SM”) in terms of task accuracy. These results show that the joint design of computation and computation not only avoids unacceptable performance degradation compared to full-stack SemCom approaches, but also enables increased accuracy for PHY layer techniques. Also described hereinbelow are results of evaluating the scalability of an example embodiment when multiplexing an increasing number of task inputs (i.e., computation channels). These results show that an example embodiment allows for multiplexing more tasks than would be possible based only on the number of communication spatial streams. Further described hereinbelow are results of comprehensively evaluating an example embodiment against existing baselines in terms of latency, energy consumption, and communication and computation efficiency. The adaptation capability of an example embodiment in a varying communication environment was also evaluated and compared with MCR2/sm to demonstrate the effectiveness of novel techniques according to an embodiment—namely, precoder/postcoder response and task-oriented pilot transmission—in addressing short-term and long-term changes, respectively. All results are based on processing a full 64-element batch. In experiments that involved MIMO computation-enabled approaches, the metrics were normalized by the number of multiplexed tasks, thereby providing average values per input.

### Example Task Accuracy

To evaluate task accuracy, 4 tasks were multiplexed on 8 communication channels for image classification, while 2 tasks were multiplexed on 8 communication channels for sentiment analysis. This setup establishes a fair comparison of an example embodiment with existing baselines, the latter of which lack multiplexing support for more tasks than physical streams. It should be noted that full-stack baselines achieve identical accuracy in both LOS and NLOS, because using a communication standard ensures that the exact representation transmitted from a mobile device is received at an edge server. Accordingly, the results of full-stack baselines are channel-independent and described only once. In contrast, latent representations in MCR2/sm, PhyDNN/ss, and an example embodiment are directly influenced by a wireless environment.

Table 1 below presents image classification accuracy results for different versions of WRN based on CIFAR-10. These results show that an example embodiment delivers consistently high performance across all architectures and conditions. Specifically, it outperforms existing approaches under both LOS and NLOS conditions. The advantage over MCR2/sm stems from an example embodiment's joint optimization of communication and computation, while MCR2/sm uses a linear precoder and postcoder that are designed separately and thus suboptimal. Likewise, the performance gain over PhyDNN/ss may be due to an example embodiment's ability to adapt to varying channel conditions. An example embodiment exhibits remarkable robustness, and maintains performance within 4% when transitioning from LoS to NLOS, e.g., from 94.48% to 90.92%, using WRN-28-10. This represents an improvement of 4.61% and 4.16% over MCR2/sm in the same conditions. An example embodiment's robustness is further evident in challenging scenarios. Even with the smallest architecture (i.e., WRN-10-4), an example embodiment achieves 85.76% accuracy in NLOS, thereby surpassing the performance of MCR2/sm (85.36%) and PhyDNN/ss (85.25%) under favorable LoS conditions by 0.40% and 0.51%, respectively. While full-stack SemCom baselines achieve highest accuracy, it comes at the cost of increased latency as detailed hereinbelow. In contrast, an example embodiment attains comparable performance (93.69% with WRN-16-8) with substantially lower latency.

TABLE 1
Experimental evaluation of image classification using
an example embodiment and existing baselines
with different DNNs on CIFAR-10.

| | | | | | |
|---|---|---|---|---|---|
| MNet | BF-9 | BF-3 | MCR2 | PhyDNN | SM |

WRN-28-10

| | | | | | | |
|---|---|---|---|---|---|---|
| LoS | 94.74% | 96.88% | 96.42% | 89.87% | 92.50% | 94.48% |
| NLoS | | | | 86.76% | 88.23% | 90.92% |

WRN-16-8

| | | | | | | |
|---|---|---|---|---|---|---|
| LoS | 93.86% | 95.96% | 95.44% | 89.17% | 91.85% | 93.69% |
| NLoS | | | | 84.97% | 87.05% | 89.46% |

WRN-10-4

| | | | | | | |
|---|---|---|---|---|---|---|
| LoS | 87.71% | 91.38% | 90.13% | 85.36% | 85.25% | 87.29% |
| NLoS | | | | 83.40% | 83.34% | 85.76% |

Tables 2 and 3 below present image classification accuracy results for different versions of the WRN and using the CIFAR-100 and SVHN datasets, respectively. An example embodiment's performance was compared with existing baselines for all three DNN models used this task. The results in Tables 2 and 3 show that an example embodiment experiences only slight performance degradation compared to existing full-stack SemCom approaches, while surpassing all existing PHY layer SemCom approaches. Moreover, comparing the results in a cross-dataset fashion shows that multiplexing performance depends on task complexity, e.g., recognizing images from 10 classes (CIFAR-10, SVHN) or 100 classes (CIFAR-100), as discussed hereinbelow. It should be noted that the performance of full-stack SemCom approaches is not affected by the communication scenario.

TABLE 2
Experimental evaluation of image classification performance
using an example embodiment and existing baselines with
different DNNs on CIFAR-100.

| | | | | | |
|---|---|---|---|---|---|
| MNet | BF-9 | BF-3 | MCR2 | PhyDNN | SM |

WRN-28-10

| | | | | | | |
|---|---|---|---|---|---|---|
| LoS | 79.20% | 81.32% | 80.63% | 74.68% | 75.75% | 78.87% |
| NLoS | | | | 71.46% | 72.52% | 76.62% |

WRN-16-8

| | | | | | | |
|---|---|---|---|---|---|---|
| LoS | 76.84% | 77.58% | 77.12% | 71.87% | 72.74% | 75.13% |
| NLoS | | | | 68.14% | 69.30% | 72.31% |

WRN-10-4

| | | | | | | |
|---|---|---|---|---|---|---|
| LoS | 66.23% | 69.08% | 67.38% | 60.55% | 61.43% | 63.58% |
| NLoS | | | | 58.42% | 59.88% | 61.14% |

TABLE 3
Experimental evaluation of image classification performance
using an examplembodiment and existing baselines with
different DNNs on SVHN.

| | | | | | |
|---|---|---|---|---|---|
| MNet | BF-9 | BF-3 | MCR2 | PhyDNN | SM |

WRN-28-10

| | | | | | | |
|---|---|---|---|---|---|---|
| LoS | 96.88% | 97.11% | 97.08% | 92.48% | 94.92% | 96.51% |
| NLoS | | | | 90.02% | 92.68% | 94.73% |

WRN-16-8

| | | | | | | |
|---|---|---|---|---|---|---|
| LoS | 96.69% | 96.84% | 96.67% | 92.45% | 95.27% | 96.32% |
| NLoS | | | | 89.40% | 92.97% | 94.91% |

WRN-10-4

| | | | | | | |
|---|---|---|---|---|---|---|
| LoS | 94.33% | 94.84% | 94.53% | 91.14% | 92.67% | 93.61% |
| NLoS | | | | 89.02% | 90.80% | 92.12% |

Table 4 below shows results of evaluating accuracy in binary classification of sentiments using a transformer architecture for text processing. The results follow the same trend discussed hereinabove for image classification: an example embodiment is the most effective approach compared to existing PHY layer SemCom approaches and achieves accuracy values comparable to the ones of existing full protocol stack baselines.

TABLE 4
Experimental evaluation of sentiment analysis performance
using an example embodiment and existing baselines
for a transformer on LRA.

| Transformer | MNet | BF-9 | BF-3 | MCR2 | PhyDNN | SM |
|---|---|---|---|---|---|---|
| LoS | 64.39% | 66.06% | 65.81% | 60.93% | 61.04% | 64.02% |
| NLoS | | | | 59.44% | 59.52% | 62.83% |

### Example Semantic Scalability

Described hereinbelow is an evaluation of the scalability of an example embodiment in terms of how task accuracy varies based on the number of multiplexed tasks.

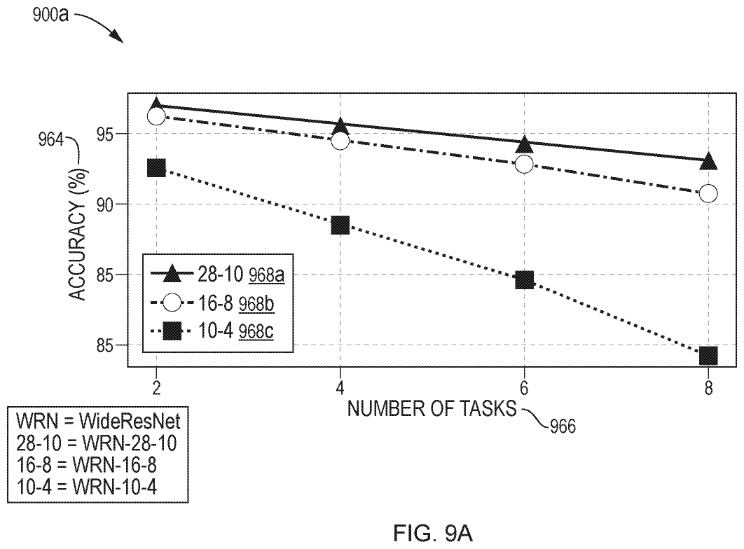

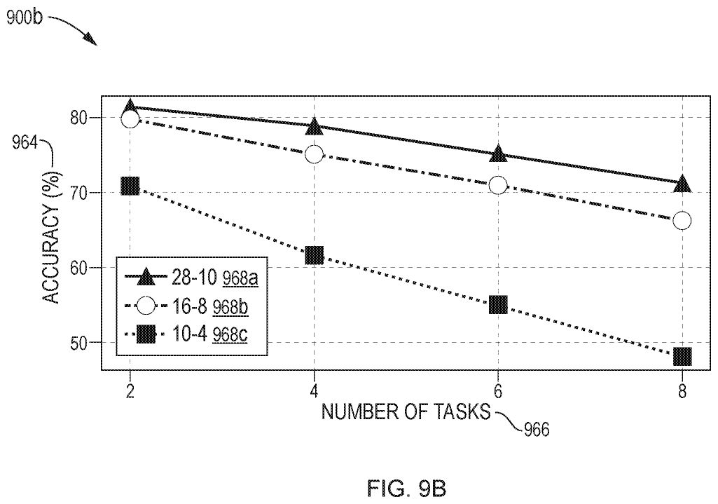

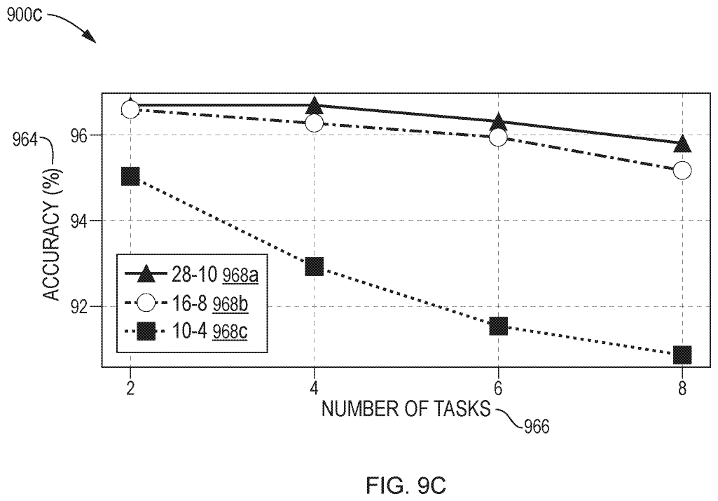

FIGS. 9A-9C are plots 900a-900c depicting accuracy 964 results of scalability evaluations for image classification on CIFAR-10, CIFAR-100, and SVHN, respectively, with 4 communication channels and varying numbers of multiplexed task inputs 966 for DNNs 968a-968c.

FIGS. 9A-9C illustrate an extensive scalability evaluation performed using an image classification task and testing performance of the different DNNs 968a-968c on the three considered datasets. In general, the results demonstrate that an example embodiment can multiplex more tasks than would be possible based only on the number of physical streams supported by a given transceiver hardware, without noticeable degradation in individual task performance. More in detail, comparing the results in the plots 900a-900c-which results were obtained using 4 communication streams and multiplexing 2, 4, 6, and 8 tasks 966 at a time-shows that any decrease in performance is linked with the difficulty of the task, e.g., CIFAR-10 in the plot 900a compared to CIFAR-100 in the plot 900b, and the complexity of the DNN used for processing, e.g., the WRN-28-10 DNN 968a compared to the WRN-10-4 DNN 968c. For example, FIG. 9A shows that the WRN-28-10 DNN 968a allows multiplexing 8 tasks with a task accuracy of 93.09%. Thus, multiplexing 8 tasks has only 4% less accuracy than the accuracy (97.01%) achievable multiplexing 2 tasks with the same DNN 968a, while also reducing latency by 4^{x}—i.e., 8 streams are simultaneously processed instead of only 2—due to semantic multiplexing according to an embodiment. The same trend is visible in FIGS. 9B and 9C, with accuracy decrease rates that are dataset- and DNN-specific. For example, for the more complex CIFAR-100 dataset (FIG. 9B), accuracy decreases by about 10% when multiplexing 8 streams (71.19%) instead of 2 (81.29%) and its values are consistently smaller than those achievable with the simpler 10-class datasets in CIFAR-10.

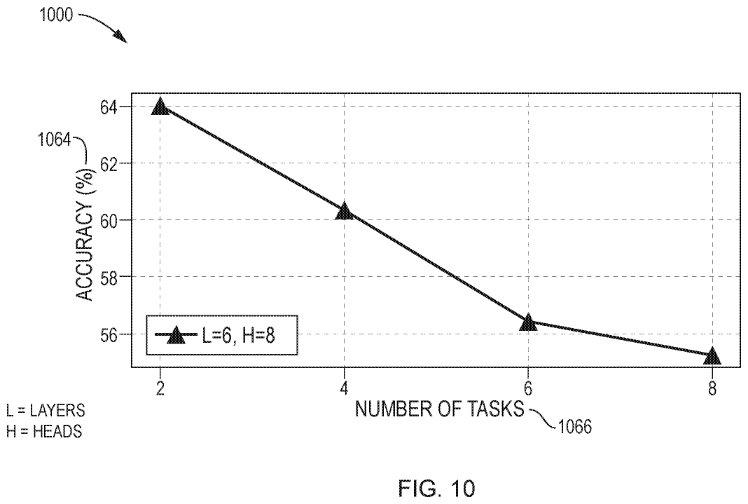

FIG. 10 is a plot 1000 depicting accuracy 1064 results of scalability evaluations for sentiment analysis with 2 communication channels and varying numbers of multiplexed task inputs 1066 for a transformer architecture with 6 layers (L) and 8 attention heads (H).

FIG. 10 analyzes scalability of an example embodiment on a sentiment analysis task that uses transformers. The evaluation was performed using 2 communication channels. The results are also positive in this case, with a less than 10% accuracy decrease when increasing the number of multiplexed tasks 1066 from 2 to 8.

Table 5 shows the impact of disjoint processing—which is applied to task inputs before binding at a transmitter (e.g., as described hereinabove with respect to FIG. 4)—on the scalability of an example embodiment. Specifically, the performance of an example embodiment on image classification with CIFAR-10 was evaluated when doubling the number of kernels in a convolutional layer used for disjoint processing. The results were obtained using 4 communication channels while multiplexing 6 and 8 tasks and show that increasing the number of kernels improves performance, especially when increasing the number of tasks to be multiplexed. This confirms that applying a preprocessing step prior to binding helps to enforce orthogonality among computation channels and can be optimized based on specific task and hardware constraints.

TABLE 5
Image classification accuracy of an example embodiment for
different DNNs on CIFAR-10 with varying numbers of kernels
in disjoint processing for 6 and 8 multiplexed tasks.

| | |
|---|---|
| 1× Kernels | 2× Kernels |

WRN-28-10

| | | |
|---|---|---|
| Tasks = 6 | 94.32% | 96.21% |
| Tasks = 8 | 93.09% | 95.82% |

WRN-16-8

| | | |
|---|---|---|
| Tasks = 6 | 92.85% | 93.93% |
| Tasks = 8 | 90.74% | 91.82% |

WRN-10-4

| | | |
|---|---|---|
| Tasks = 6 | 84.57% | 88.48% |
| Tasks = 8 | 79.25% | 80.52% |

### Example Resource Efficiency

An example embodiment was evaluated for computational analysis against existing baselines on the CIFAR-10 dataset using 8 communication channels and 4 multiplexed task inputs. The following metrics were obtained to evaluate resource efficiency (i.e., complexity):
a) end-to-end execution time (i.e., latency);
b) energy consumption at a mobile device;
c) total number of transmitted symbols from the mobile device to an edge server (i.e., communication efficiency); and
d) total number of DNN parameters and operations performed by the mobile device (i.e., computation efficiency).

For the latency and energy consumption measurements, evaluations were performed over 100 full executions (epochs) of a test set. To obtain reliable estimates of energy consumption, instantaneous power readings were sampled more than 1,000 times during data acquisition and averaged.

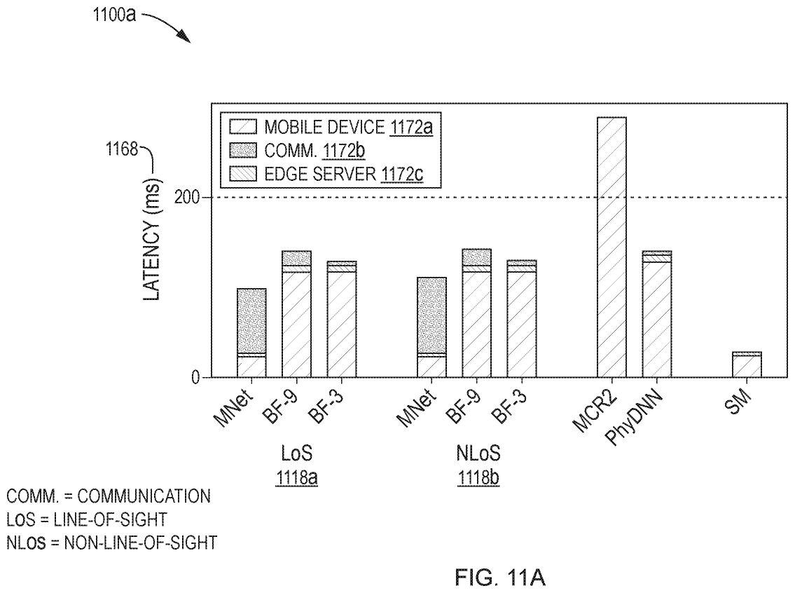

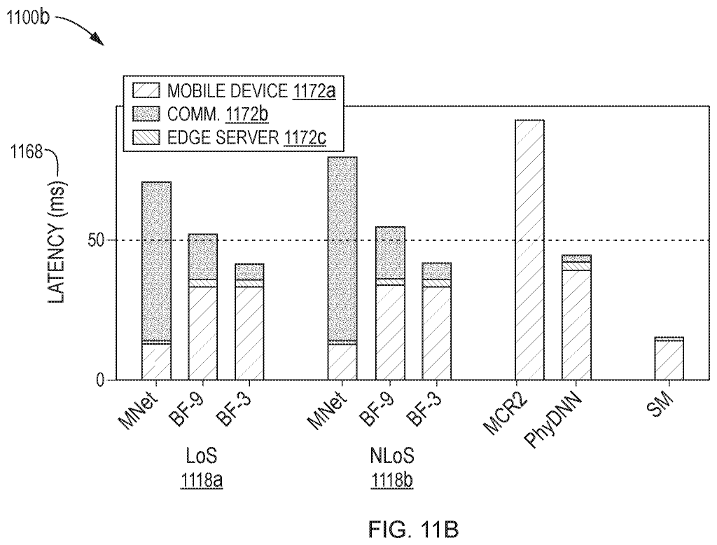

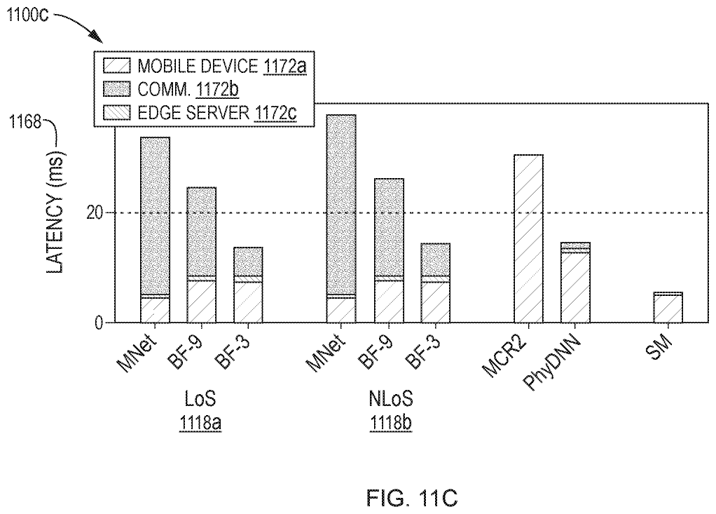

FIGS. 11A-11C are plots 1100a-1100c depicting end-to-end latency results 1168 for WRN-28-10, WRN-16-8, and WRN-10-4 architectures, respectively, in terms of computation time 1172a, communication latency 1172b, and inference time 1172c under LoS 1118a and NLOS 1118b scenarios using existing full-stack (MNet, BF-9, and BF-3) and PHY layer (MCR2 and PhyDNN) approaches compared with an example embodiment (SM).

The end-to-end latency 1168 accounts for (i) the computation time 1172a on a mobile device, i.e., a head model (e.g., DNN); (ii) the communication latency 1172b of sending latent representations; and (iii) the inference time 1172c on an edge server, i.e., tail model (e.g., DNN). FIGS. 11A, 11B, and 11C depict a breakdown of the latency results 1168 for the WRN-28-10, WRN-16-8, and WRN-10-4 architectures, respectively, under the LoS 1118a and NLOS 1118b scenarios. For approaches that employ superposition and precoding at a mobile device, and postcoding and decomposition at an edge server, the latency overhead of these approaches is included in the inference times 1172c. Across all settings, an example embodiment (SM) consistently demonstrates lower latency 1168 compared to all existing baselines, including both existing full protocol stack (MNet, BF-9, and BF-3) and PHY layer (MCR2 and PhyDNN) approaches.

As shown in FIGS. 11A-11C, the communication latency 1172b is the primary bottleneck for the full protocol stack approaches-especially in the NLOS scenarios 1118b, where frequent retransmissions further increase delay. By transmitting task-relevant features directly at the PHY layer, an example embodiment (SM) avoids such overhead. For instance, MNet/ms incurs up to 630× higher communication latency than an example embodiment (SM) in the NLOS scenario 1118b. PhyDNN/ss also operates at the PHY layer and maintains consistent latency across channel conditions. However, an example embodiment (SM) can transmit semantic features in parallel across multiple streams and thereby achieve a 32× reduction in average latency compared to PhyDNN/ss.

Beyond communication efficiency, an example embodiment (SM) also achieves a notable reduction in the computation latency 1172a compared to existing PHY layer baselines. By performing multi-task semantic processing, an example embodiment can lower the computation latency 1172a by up to 11.3× and 5.0× compared to MCR2/sm and PhyDNN/ss, respectively.

Overall, averaged across all backbones and channel conditions, an example embodiment (SM) reduces the total latency 1168 by 4.46× over MNet/ms, 4.55× over BF-9/ss, 3.82× over BF-3/ss, 8.53× over MCR2/sm, and 4.09× over PhyDNN/ss.

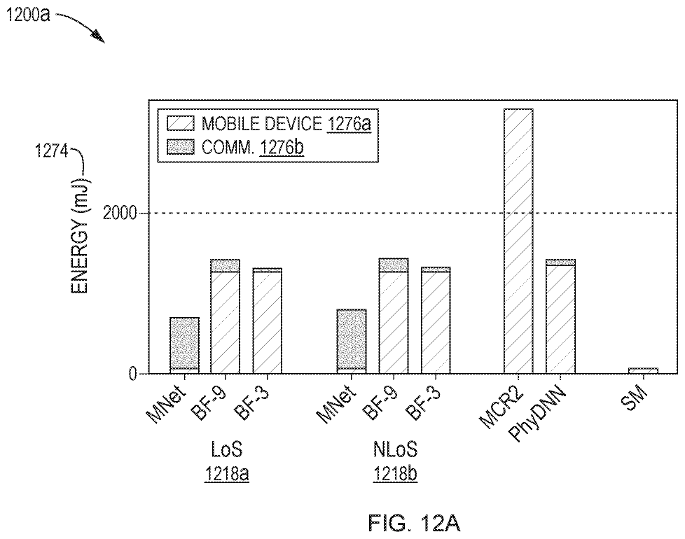

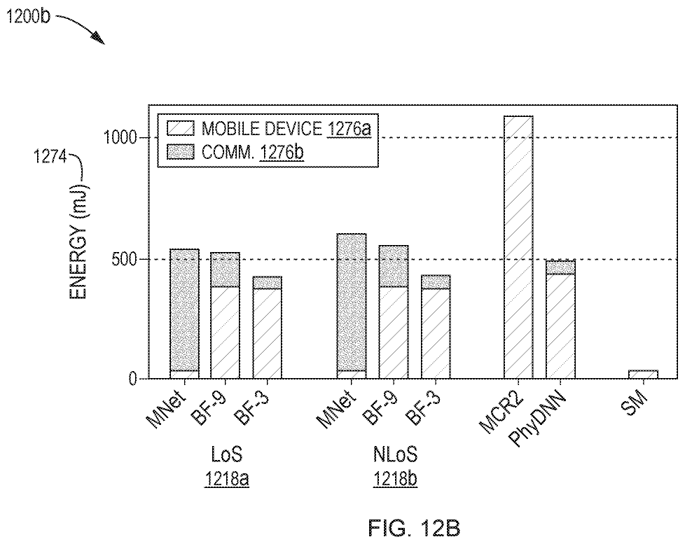

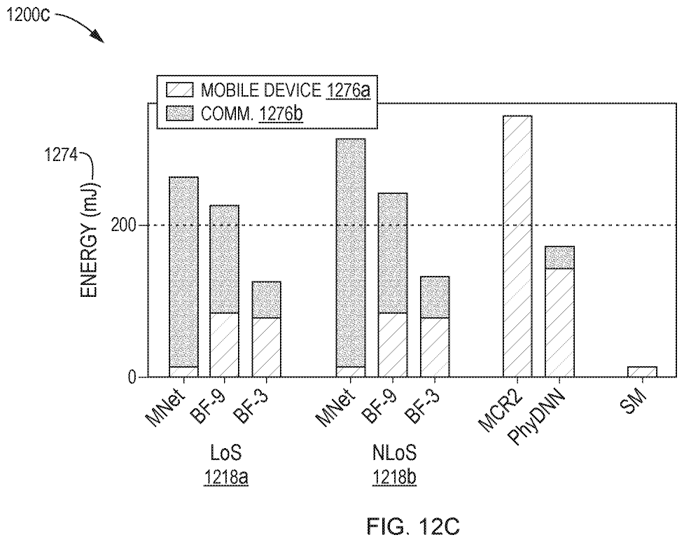

FIGS. 12A-12C are plots 1200a-1200c depicting mobile device energy consumption 1274 for WRN-28-10, WRN-16-8, and WRN-10-4 architectures, respectively, in terms of computation energy 1276a and communication energy 1276b under LoS 1218a and NLOS 1218b scenarios using existing full-stack (MNet, BF-9, and BF-3) and PHY layer (MCR2 and PhyDNN) approaches compared with an example embodiment (SM).

The plots 1200a-1200c evaluate the energy consumption 1274, including (i) the energy consumption 1276a during transmitter-side ML model (e.g., DNN) execution; and (ii) the energy 1276b consumed to communicate latent symbols. As illustrated in FIGS. 12A-12C, the overall energy 1274 footprint varies significantly with the model size and communication environment. Existing full-stack baselines (MNet, BF-9, and BF-3) incur high communication energy 1276b, especially in the NLOS scenario 1218b, while MCR2/sm incurs high computation energy 1276a due to its heavy processing on the mobile device.

In contrast, an example embodiment (SM) maintains a consistently low energy profile across all architectures. An example embodiment (SM) achieves up to 187.51× lower communication energy 1276b than existing full-stack approaches (MNet, BF-9, and BF-3) on average with WRN-10-4, and reduces the computation energy 1276a by 33.97× compared to existing task-oriented SemCom approaches on average with WRN-28-10. Even in the most demanding case of WRN-28-10 under the NLOS scenario 1218b, an example embodiment (SM) remains significantly more efficient, with a total energy usage 1274 well below all existing baselines (e.g., 11.36× lower than MNet/ms). This efficiency stems from an example embodiment's strategic computation distribution, where only the first layer and optional lightweight precoding are executed on a mobile device, while energy-intensive deeper layers are offloaded to an edge server. Furthermore, an example embodiment's efficiency gain arises from task multiplexing, which reduces the average energy consumption per input.

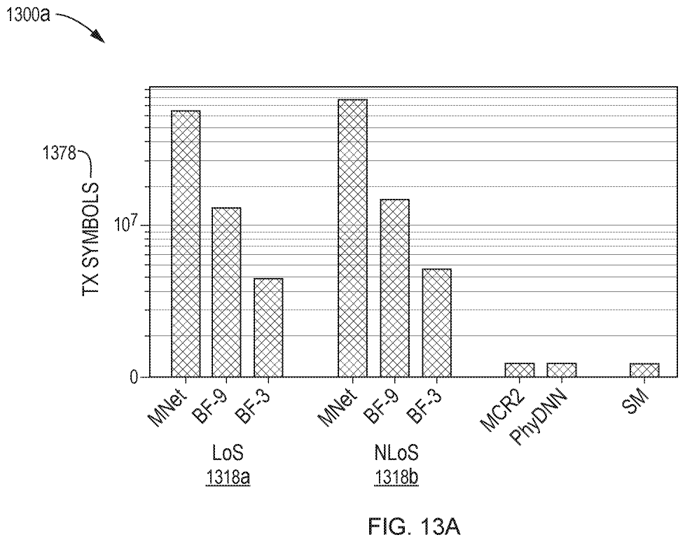

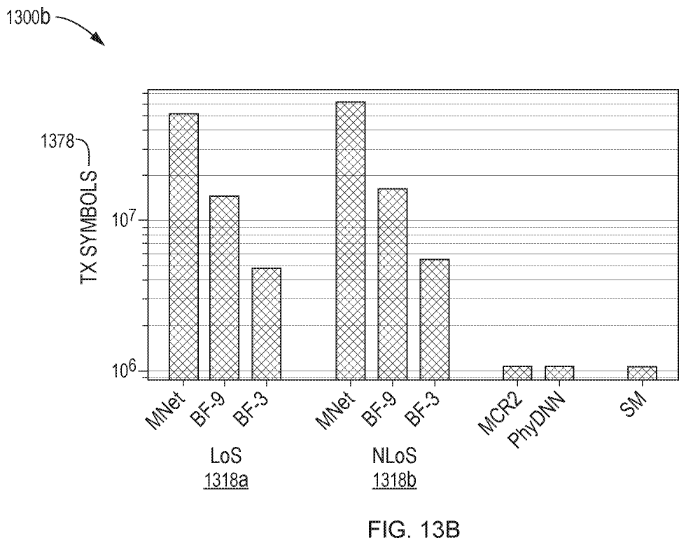

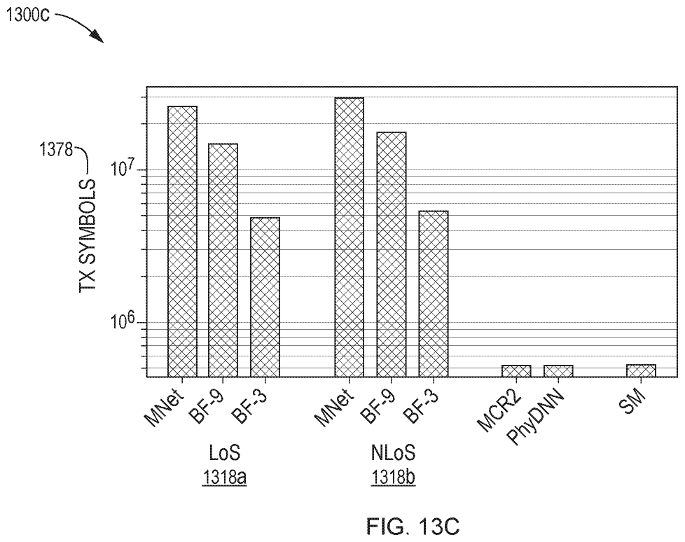

FIGS. 13A-13C are plots 1300a-1300c depicting communication overhead 1378 for WRN-28-10, WRN-16-8, and WRN-10-4 architectures, respectively. The plots 1300a-1300c show the total number of transmitted I/Q symbols 1378—including both payload and protocol overhead—for the different DNNs measured for an example embodiment (SM) and various existing approaches under both LoS 1318a and NLOS 1318b conditions.

As shown in FIGS. 13A-13C, the existing full protocol stack baselines (MNet, BF-9, and BF-3) exhibit the highest communication overhead 1378, while an example embodiment (SM) maintains a near-constant transmission volume 1378 of just 1.3×10⁶ symbols regardless of the environment by bypassing all overhead introduced by different layers of the stack. On average, an example embodiment (SM) reduces the number of transmitted symbols 1378 by 54.24× compared to MNet/ms, 16.73× compared to BF-9/ss, and 5.56× compared to BF-3/ss across the LoS/NLOS 1318a/1318b scenarios and models.

Table 6 below shows (i) the number of parameters in terms of memory usage and (ii) the number of floating-point operations (FLOPs) in terms of multiply-accumulate (MAC) operations required to execute head ML models (e.g., DNNs) across all evaluated approaches and WRN architectures. While MCR2/sm exhibits the highest computational load at a transmitter—reaching over 36 MB and 5.3 billion MACs in WRN-28-10—other existing full-stack baselines also incur significant memory and compute overhead. In contrast, an example embodiment (SM) guarantees high task performance, such as shown in Table 1 (described hereinabove), with a substantially lower computational and memory footprint. For instance, with WRN-10-4, an example embodiment (SM) only requires 42.9 KB of memory and 13.2 million MAC operations per second (MMac), which is significantly lower than all existing baselines. Even in deeper architectures like WRN-28-10, example embodiment (SM) maintains computation overhead below 100 MMac and memory footprint under 0.5 MB.

TABLE 6
Memory and computational load of head
ML models on a mobile device.

| | | | | |
|---|---|---|---|---|
| MNet | BF | MCR2 | PhyDNN | SM |

WRN-28-10

| | | | | | |
|---|---|---|---|---|---|
| Params (KB) | 100 | 719 | 36,474 | 1,642 | 216 |
| FLOPs (MMac) | 47 | 575 | 5,399 | 1,830 | 92 |

WRN-16-8

| | | | | | |
|---|---|---|---|---|---|
| Params (KB) | 66 | 328 | 1,0957 | 464 | 67 |
| FLOPs (MMac) | 27 | 389 | 1,612 | 536 | 40 |

WRN-10-4

| | | | | | |
|---|---|---|---|---|---|
| Params (KB) | 5 | 15 | 1,795 | 48 | 5 |
| FLOPs (MMac) | 3 | 28 | 275 | 65 | 7 |

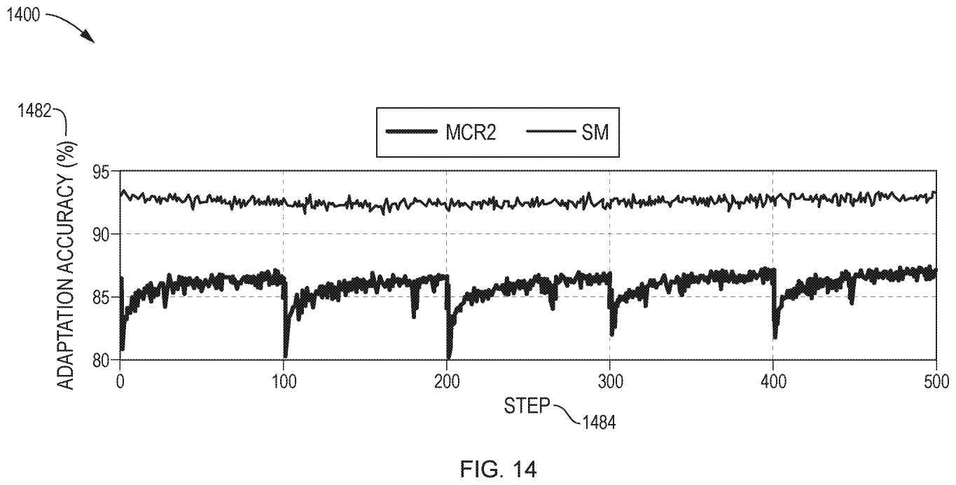

FIG. 14 is a plot 1400 comparing an example embodiment (SM) and the existing MCR2/sm baseline in terms of accuracy 1482 of inference-time adaptation to varying channels at each inference step 1484.

A dynamic wireless channel was simulated by changing positions of a transmitter and receiver every 100 inference steps 1484, which resulted in new CSI snapshots. Image classification accuracy on CIFAR-10 using WRN-28-10 was recorded continuously to assess each approach's ability to maintain task performance under these variations. As shown in FIG. 14, an example embodiment (SM) maintains consistently high accuracy throughout the adaptation sequence, while MCR2/sm exhibits frequent and severe drops in performance. This differing performance stems from MCR2/sm's dependence on an iterative precoding model that solves an optimization problem for each new CSI snapshot. However, this approach introduces instability, especially when a channel varies rapidly, and leads to significant task performance degradation. In contrast, an example embodiment (SM) may employ an optional stochastic, learnable precoder to handle dynamic channel conditions. The precoder may incorporate randomness into its design to compensate for channel distortions and enable generalization across diverse environments, thereby ensuring stable performance without runtime overhead. Quantitatively, an example embodiment (SM) achieves an average classification accuracy 1482 of 92.56% over 500 adaptation steps 1484, with a minimum of 91.55% and a maximum of 93.33%. In contrast, MCR2/sm accuracy 1482 is on average only 85.88%, with decreases as low as 80.33%.

### Example Method Embodiment

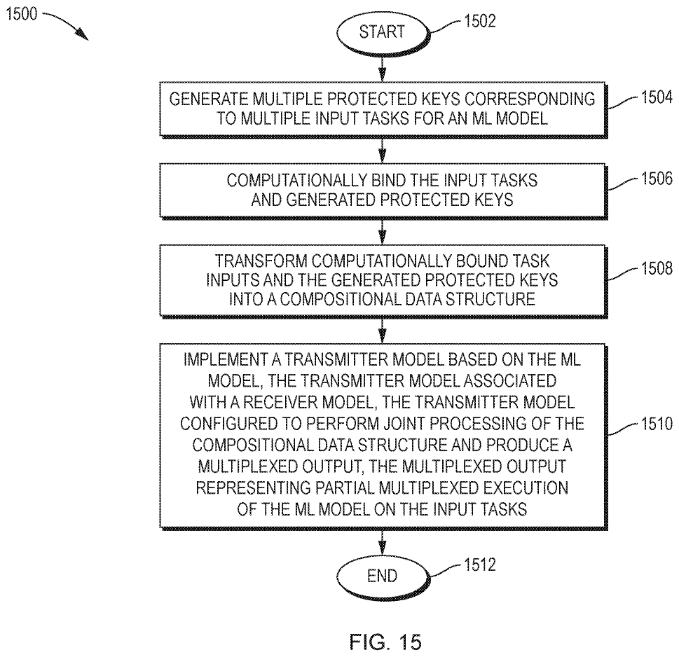

FIG. 15 is a flow diagram of an example embodiment of a computer-implemented method 1500 of multiplexing. The method 1500 begins 1502 and comprises generating (1504) multiple protected keys (e.g., 308a-308c (FIG. 3)) corresponding to multiple task inputs (e.g., 102a-102n (FIG. 1), 202a-202d (FIG. 2), 302a-302c (FIG. 3), 402a-402c (FIG. 4), 602a-602c (FIG. 6), 702a-702b (FIG. 7)) for an ML model (e.g., 405 (FIG. 4)). The method 1500 further comprises computationally binding (1506) the input tasks and generated protected keys. The method 1500 further comprises transforming (1508) computationally bound input tasks and the generated protected keys into a compositional data structure (e.g., 121 (FIG. 1)). The method 1500 further comprises implementing (1510) a transmitter model (e.g., 140 (FIG. 1), 340 (FIG. 3), 640 (FIG. 6), 740 (FIG. 7)) based on the ML model. The transmitter model is associated with a receiver model (e.g., 150 (FIG. 1), 350 (FIG. 3), 650 (FIG. 6), 750 (FIG. 7)). The transmitter model is configured to perform joint processing of the compositional data structure and produce a multiplexed output (e.g., 128 (FIG. 1), 528 (FIG. 5), 628 (FIG. 6)). The method 1500 thereafter ends 1512 in the example embodiment.

### Example Technical Challenges and Improvements

An example technical challenge overcome by embodiments is devising a task-independent technique to extract and map latent representations into PHY layer waveforms. An example system according to an embodiment may provide a new information-theoretical framework where the joint design of communication and computation is enabled by incorporating a wireless channel model into the system as a non-learnable function (described hereinabove). Existing approaches address communication and computing separately. In contrast, an example embodiment may learn semantic coding in addition to a processing task end-to-end, thereby effectively compensating for distortion patterns caused by communication channel(s), while contributing to the processing for task execution.

Another example technical challenge overcome by embodiments is maintaining orthogonality of learned semantic representations with dynamic channels. An example embodiment may provide a new channel sounding technique where pre-defined task inputs are sent by a transmitter and processed as semantic pilots (described hereinabove). Because the task inference result for such pilots is known at a receiver, the transmitter and receiver can be tuned based on an updated wireless channel and task loss backpropagated through a computation channel corresponding to the semantic pilot. Existing approaches only address communication pilots and fail to properly adapt to changing wireless channel conditions as discussed hereinabove. Because an example embodiment may be trained in an end-to-end manner, over-the-air channel effects can be leveraged as part of an overall computation pipeline, thereby contributing to task execution.

An example technical improvement of embodiments is the introduction of a new semantic orthogonalization layer that can be added on top of existing multiplexing approaches such as space-, time-, frequency-, and code-division techniques. MIMO and OFDM are some of the most established multiplexing approaches in modern communication systems such as Wi-Fi 7 and 5G. An example embodiment can be integrated with such techniques to realize an ultra-low latency edge computing system. For instance, semantically orthogonal streams according to an embodiment can be simultaneously processed and transmitted while guaranteeing suitable final task performance for each multiplexed task. By creating protected channels for each task, an example embodiment can enable both computation and communication in superposition, thus drastically reducing overall task execution time.

### Example Advantages

Embodiments deliver a groundbreaking framework that multiplexes several tasks on a single physical representation. An example embodiment may orthogonalize task representations at the semantic level, thereby enabling their joint processing and transmission to a receiver, which demultiplexes the tasks and completes processing to obtain results. In this way, an example embodiment can drastically reduce overall end-to-end latency caused by task execution.

Further, embodiments provide a novel semantic channel sounding technique for dynamically adapting a transmitter and receiver in the inference phase to preserve semantic orthogonality among computation and communication channels, thereby accounting for a varying wireless environment.

Example embodiments were extensively evaluated with real-world experiments. An example embodiment was prototyped using MIMO SDRs as transmitter and receiver radio frontends and a Jetson Orin Nano board as a mobile device. An example embodiment was evaluated experimentally and compared with existing baseline approaches in SemCom on two tasks—image classification and sentiment analysis—to evaluate efficacy on different input types (i.e., images and text) and using different processing functions (i.e., ResNets and transformers). Experiments on system scalability show that an example embodiment enables multiplexing 8 tasks on 4 communication channels while maintaining accuracy comparable to multiplexing 4 tasks (i.e., with a difference of less than 2.5%). An example embodiment decreases end-to-end latency (i.e., communication plus computation) by more than 7× on average and reduces energy consumption and communication load by more than 25× and 54×, respectively, compared to existing baseline approaches.

Moreover, embodiments validate a revolutionary new concept: the number of tasks that can be semantically multiplexed in a communication system is greater than the number of available physical streams.

Further advantages offered by embodiments include, for non-limiting examples:
a) Improving communication efficiency compared to distributed edge computing systems, which suffer from major bottlenecks due to communication delay
b) Improving computation efficiency compared to MIMO semantic communication methods, which experience major bottlenecks due to time incurred for computation
c) Processing data at a high rate by, e.g., processing multiple inputs at once (i.e., computation in superposition)
d) Communicating data at a high rate by, e.g., transmitting multiple streams at once (i.e., communication in superposition)
e) Adapting to varying wireless conditions by, e.g., performing task-oriented channel sounding
f) Reducing total ML model (e.g., DNN) execution latency
g) Reducing energy consumption of mobile devices, thereby resulting in longer battery life
h) Preserving AI/ML task performance within a satisfactory threshold
i) Increasing communication efficiency by, e.g., transmitting only compressed task-specific features that are robust against communication-related distortions
j) Reducing total communication network by, e.g., avoiding encapsulation of data in network protocol layers

### Example Applications

Applications of embodiments include, for non-limiting examples, VR headsets and AR smart glasses, where resource constrained mobile devices may need to continuously perform high-rate low-latency AI/ML processing tasks, such as semantic segmentation.

Another example application of embodiments is any edge computing platform that requires large quantities of data to be offloaded and processed at a high rate by servers, where computation and communication latency cause a performance bottleneck.

### Computer Support

FIG. 16 is a block diagram of an example embodiment of an internal structure of a computer 1600 in which various embodiments of the present disclosure may be implemented. The computer 1600 contains a system bus 1672, where a bus is a set of hardware lines used for data transfer among the components of a computer or digital processing system. The system bus 1672 is essentially a shared conduit that connects different elements of a computer system (e.g., processor, disk storage, memory, I/O ports, network ports, etc.) that enables the transfer of information between the elements. Coupled to the system bus 1672 is an I/O device interface 1654 for connecting various input and output devices (e.g., keyboard, mouse, displays, printers, speakers, etc.) to the computer 1600. A network interface 1656 allows the computer 1600 to connect to various other devices attached to a network (e.g., global computer network, wide area network, local area network, etc.). A memory 1658 provides volatile or non-volatile storage for computer software instructions 1680 and data 1662 that may be used to implement embodiments (e.g., the computer-based system 110 (FIG. 1), the architecture 200 (FIG. 2), the architecture 300 (FIG. 3), the architecture 400 (FIG. 4), the architecture 500 (FIG. 5), the probabilistic system model 600 (FIG. 6), the architecture 700 (FIG. 7), the experimental setup 800 (FIG. 8), and the method 1500 (FIG. 15), etc.) of the present disclosure, where the volatile and non-volatile memories are examples of non-transitory media. A disk storage 1664 provides non-volatile storage for the computer software instructions 1680 and data 1662 that may be used to implement embodiments (e.g., the computer-based system 110, the architecture 200, the architecture 300, the architecture 400, the architecture 500, the probabilistic system model 600, the architecture 700, the experimental setup 800, and the method 1500, etc.) of the present disclosure. A central processor unit 1666 is also coupled to the system bus 1672 and provides for the execution of computer instructions.

As used herein, the terms “architecture,” “framework,” “model,” and “module” may refer to any hardware, software, firmware, electronic control component, processing logic, and/or processor device, individually or in any combination, including without limitation: an application specific integrated circuit (ASIC), a field-programmable gate array (FPGA), an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods (e.g., the method 1500, etc.) described herein. It should be understood that elements of the block and flow diagrams may be implemented in software or hardware, such as via one or more arrangements of circuitry of FIG. 16, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system for multiplexing, the system comprising:
at least one processor; and
a memory with computer code instructions stored thereon, the at least one processor and the memory, with the computer code instructions, configured to cause the system to:
generate multiple protected keys corresponding to multiple input tasks for a machine learning (ML) model;
computationally bind the input tasks and generated protected keys;
transform computationally bound input tasks and the generated protected keys into a compositional data structure; and
implement a transmitter model based on the ML model, the transmitter model associated with a receiver model, the transmitter model configured to perform joint processing of the compositional data structure and produce a multiplexed output, the multiplexed output representing partial multiplexed execution of the ML model on the input tasks.

2. The system of claim 1, wherein the at least one processor and the memory, with the computer code instructions, are further configured to cause the system to:
implement a modulator configured to generate at least one modulated output based on the multiplexed output, the at least one modulated output capable of being transmitted via at least one communications channel to the receiver model to produce multiple task outputs corresponding to the input tasks, the task outputs representing full multiplexed execution of the ML model on the input tasks.

3. The system of claim 2, wherein the at least one processor and the memory, with the computer code instructions, are further configured to cause the system to:
implement a stochastic precoding model configured to transform the multiplexed output into an encoded output based on channel state information (CSI) associated with the at least one communications channel;
wherein the modulator is further configured to generate the at least one modulated output based on the encoded output.

4. The system of claim 3, wherein the stochastic precoding model is configured to transform the multiplexed output by:
transforming the multiplexed output into a complex tensor;
computing a precoding tensor based on the complex tensor and the CSI; and
generating the encoded output based on a probability distribution associated with the computed precoding tensor.

5. The system of claim 3, wherein the at least one processor and the memory, with the computer code instructions, are further configured to cause the system to:
dynamically determine the CSI by:
transmitting pilot data to a remote system associated with the receiver model; and
receiving the CSI from the remote system, wherein the received CSI is adapted to at least one condition of the at least one communications channel.

6. The system of claim 3, wherein the at least one processor and the memory, with the computer code instructions, are further configured to cause the system to:
dynamically determine the CSI by:
generating a pilot input based on training data associated with the ML model, the pilot input having a predetermined output;
injecting the generated pilot input into the input tasks at an index determined at least in part based on a seed value associated with the transmitter model and the receiver model; and
determining the CSI based on a difference between the predetermined output and an output of the task outputs at the index.

7. The system of claim 2, wherein the at least one modulated output includes a plurality of modulated outputs, and wherein the modulator is configured to generate the plurality of modulated outputs using a multiplexing technique, wherein the multiplexing technique is spatial multiplexing, time-division multiplexing, frequency-division multiplexing, or code-division multiplexing.

8. The system of claim 2, wherein the transmitter model includes a first set of parameters, wherein the receiver model includes a second set of parameters, wherein the receiver model is associated with a demodulator, wherein the at least one communications channel is associated with a channel model, and wherein the at least one processor and the memory, with the computer code instructions, are further configured to cause the system to:
determine the first set of parameters and second set of parameters by:
generating a training metric based on a weighting metric and probability distributions associated with: (i) the transmitter model, (ii) the modulator, (iii) the channel model, (iv) the receiver model, and (v) the demodulator; and
optimizing the generated training metric based on training data associated with the ML model.

9. The system of claim 1, wherein, in implementing the transmitter model, the at least one processor and the memory, with the computer code instructions, are configured to cause the system to:
partition the ML model into a pair of processing functions;
wherein the transmitter model is configured to perform the joint processing based on a first processing function of the pair of processing functions.

10. The system of claim 9, wherein the ML model includes a non-differentiable function, and wherein, in partitioning the ML model, the at least one processor and the memory, with the computer code instructions, are configured to cause the system to:
transform the non-differentiable function into a differentiable function; and
partition the differentiable function into the pair of processing functions.

11. The system of claim 10, wherein, in transforming the non-differentiable function, the at least one processor and the memory, with the computer code instructions, are configured to cause the system to re-parameterize the non-differentiable function.

12. The system of claim 1, wherein the generated protected keys are configured to provide corresponding protected subspaces for processing the input tasks.

13. The system of claim 1, wherein, in computationally binding the input tasks and generated protected keys, the at least one processor and the memory, with the computer code instructions, are configured to cause the system to use a holographic reduced representations (HRR) technique.

14. The system of claim 1, wherein, in transforming computationally bound input tasks and the generated protected keys into the compositional data structure, the at least one processor and the memory, with the computer code instructions, are configured to cause the system to use an element-wise summation technique.

15. The system of claim 1, wherein the at least one processor and the memory, with the computer code instructions, are further configured to cause the system to:
implement a disjoint processing model based on at least part of the transmitter model,
the disjoint processing model configured to transform the input tasks into higher-dimensional representations.

16. The system of claim 15, wherein the higher-dimensional representations are configured to isolate processing of the computationally bound input tasks.

17. The system of claim 1, wherein the input tasks relate to an object detection task, a text analysis task, an image classification task, or a sentiment analysis task.

18. The system of claim 1, wherein the system is implemented at least in part in a mobile device, and wherein the mobile device is a virtual reality (VR) device, an augmented reality (AR) device, smart glasses, a smartphone, a smartwatch, a tablet, a laptop, a robot, a wearable device, a medical device, an unmanned aerial vehicle (UAV), or another mobile device.

19. A computer-implemented method of multiplexing, the method comprising:
generating multiple protected keys corresponding to multiple input tasks for a machine learning (ML) model;
computationally binding the input tasks and generated protected keys;
transforming computationally bound input tasks and the generated protected keys into a compositional data structure;
implementing a transmitter model based on the ML model, the transmitter model associated with a receiver model, the transmitter model configured to perform joint processing of the compositional data structure and produce a multiplexed output, the multiplexed output representing partial multiplexed execution of the ML model on the input tasks; and
implementing a modulator configured to generate at least one modulated output based on the multiplexed output, the at least one modulated output capable of being transmitted via at least one communications channel to the receiver model to produce multiple task outputs corresponding to the input tasks, the task outputs representing multiplexed execution of the ML model on the input tasks.

20. A computer-implemented method of demultiplexing, the method comprising:
implementing a demodulator configured to generate a multiplexed input based on a modulated input received via at least one communications channel from a transmitter model associated with a machine learning (ML) model, the multiplexed input representing partial multiplexed execution of the ML model on multiple task inputs;
implementing a receiver model based on the ML model, the receiver model configured to perform joint processing of the multiplexed input and produce a compositional data structure;
transforming the compositional data structure into multiple task outputs computationally bound with protected keys, the task outputs representing full multiplexed execution of the ML model on the task inputs; and
computationally unbinding the task outputs from the protected keys.
